(19) United States
(12) Patent Application Publication
(10) Pub. No.: US 2017/0349058 A1
(43) Pub. Date: Dec. 7, 2017

(54) FLEET MANAGEMENT SYSTEM FOR OUTDOOR POWER EQUIPMENT

(71) Applicant: Briggs & Stratton Corporation, Wauwatosa, WI (US)

(72) Inventors: Kevin T. Bernier, Wauwatosa, WI (US); Christopher Meyers, Whitefish Bay, WI (US); Jennifer Scherer, Wauwatosa, WI (US); Peter D. Shears, Wauwatosa, WI (US); Timothy Ogden, Wauwatosa, WI (US)

(73) Assignee: Briggs & Stratton Corporation, Wauwatosa, WI (US)

(21) Appl. No.: 15/615,666

(22) Filed: Jun. 6, 2017

Related U.S. Application Data
(60) Provisional application No. 62/346,785, filed on Jun. 7, 2016.
(60) Provisional application No. 62/417,556, filed on Nov. 4, 2016.

(51) Int. Cl. B60L 11/18; G06Q 50/06; H02J 3/14; G06Q 10/06; H02J 13/00; H02J 3/32

(52) U.S. Cl. CPC B60L 11/1846; H02J 13/0086; H02J 13/0079; H02J 3/32; H02J 3/14; B60L 11/1816; G06Q 10/06; B60L 11/1861; B60L 11/1842; B60L 11/184; G06Q 50/06

(57) ABSTRACT

A fleet management system includes a connected lawn mower including a prime mover, a mower blade, and a processing circuit including a processor and memory. The processing circuit receives a cost input indicating an amount of money to complete a job, receives an on-site time for the job, receives operational data from the connected lawn mower, including a prime mover runtime, calculates an efficiency value for the connected lawn mower based on the prime mover runtime and the on-site time, calculates a profitability value for the job based on at least the cost input and the on-site time, generates an efficiency report and profitability report for the connected unit based on the calculated efficiency and profitability values, and transmits the efficiency report and the profitability report to a computing system.

### CROSS-REFERENCE TO RELATED PATENT APPLICATIONS

This application claims the benefit of U.S. Application No. 62/346,785, filed Jun. 7, 2016, and U.S. Application No. 62/417,556, filed Nov. 4, 2016, both of which are incorporated herein by reference in their entireties.

### BACKGROUND

The present invention generally relates to outdoor power equipment. More specifically, the present invention relates to a fleet management system for outdoor power equipment.

### SUMMARY

One embodiment of the invention relates to a fleet management system for use with a lawn mower. The fleet management system includes a connected lawn mower including a prime mover and at least one mower blade. The system further includes a processing circuit communicably coupled to the connected lawn mower, the processing circuit including a processor and memory, the memory structured to store instructions that are executable by the processor and cause the processing circuit to receive a cost input indicating an amount of money to complete one or more jobs, receive an on-site time for the one or more jobs, receive operational data from the connected lawn mower, wherein the operational data includes a prime mover runtime, calculate an efficiency value for the connected lawn mower based on at least the prime mover runtime and the on-site completion time, calculate a profitability value for the one or more jobs based on at least the cost input and the on-site time, generate an efficiency report for the connected unit based on the calculated efficiency value, generate a profitability report for the one or more jobs based on the calculated profitability value, and transmit the efficiency report and the profitability report to a computing system.

Another embodiment of the invention relates to a connected unit. The connected unit includes a prime mover and communication circuitry communicably coupled to a fleet management system. The fleet management system is configured to receive a cost input indicating an amount of money to complete one or more jobs, receive an on-site time for the one or more jobs, receive operational data from the connected lawn mower, wherein the operational data includes a prime mover runtime, calculate an efficiency value for the connected lawn mower based on at least the prime mover runtime and the on-site time, calculate a profitability value for the one or more jobs based on at least the cost input and the on-site time, generate an efficiency report for the connected unit based on the calculated efficiency value, generate a profitability report for the one or more jobs based on the calculated profitability value, and transmit the efficiency report and the profitability report to a computing system.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, in which:

FIG. 1 is a schematic diagram of a system for managing a fleet of outdoor power equipment, according to an exemplary embodiment;

FIG. 1A is a schematic diagram of a communication system between a connected unit and a network, according to an exemplary embodiment;

FIG. 1B is a schematic diagram of a communication system between a connected unit and a network, according to an exemplary embodiment;

FIG. 1C is a schematic diagram of a communication system between a connected unit and a network, according to an exemplary embodiment;

FIG. 1D is a schematic diagram of a communication system between a connected unit and a network, according to an exemplary embodiment;

FIG. 2 is a schematic diagram of a connected unit of the system of FIG. 1, according to an exemplary embodiment;

FIG. 3 is a schematic diagram of the fleet management system of FIG. 1;

FIG. 4 is a user interface of the fleet management system of FIG. 3, according to an exemplary embodiment;

FIG. 5 is a user interface of the fleet management system of FIG. 3, according to an exemplary embodiment;

FIG. 6 is a user interface of the fleet management system of FIG. 3, according to an exemplary embodiment; and

FIG. 7 is a user interface of the fleet management system of FIG. 3, according to an exemplary embodiment.

FIG. 8 is a user interface of the fleet management system of FIG. 3, according to an exemplary embodiment;

FIG. 9 is a user interface of the fleet management system of FIG. 3, according to an exemplary embodiment;

FIG. 10 is a user interface of the fleet management system of FIG. 3, according to an exemplary embodiment;

FIG. 11 is a user interface of the fleet management system of FIG. 3, according to an exemplary embodiment;

FIG. 12 is a user interface of the fleet management system of FIG. 3, according to an exemplary embodiment;

FIG. 13 is a user interface of the fleet management system of FIG. 3, according to an exemplary embodiment;

FIG. 14 is a user interface of the fleet management system of FIG. 3, according to an exemplary embodiment;

FIG. 15 is a user interface of the fleet management system of FIG. 3, according to an exemplary embodiment;

FIG. 16 is a user interface of the fleet management system of FIG. 3, according to an exemplary embodiment;

FIG. 17 is a user interface of the fleet management system of FIG. 3, according to an exemplary embodiment;

FIG. 18 is a user interface of the fleet management system of FIG. 3, according to an exemplary embodiment;

FIG. 19 is a user interface of the fleet management system of FIG. 3, according to an exemplary embodiment; and

FIG. 20 is a user interface of the fleet management system of FIG. 3, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to various example embodiments, as described in further detail below, providing real-time or near real-time operational updates, preemptive alerts, and various other data of outdoor power equipment may improve efficiency of overall management, scheduling, and maintenance of a fleet of such outdoor power equipment. Outdoor power equipment includes lawn mowers, riding tractors, snow throwers, fertilizer spreaders, salt spreaders, chemical spreaders, pressure washers, tillers, log splitters, zero-turn radius mowers, walk-behind mowers, wide area walk-behind mowers, riding mowers, stand-on mowers, pavement surface preparation devices, industrial vehicles such as forklifts, utility vehicles, commercial turf equipment such as blowers, vacuums, debris loaders, overseeders, power rakes, aerators, sod cutters, brush mowers, etc.

When used to manage a fleet of outdoor power equipment, a system providing contemporaneous updates and alerts may be beneficial to improve staffing needs and monitor many units of outdoor power equipment at once. Contemporaneous updates and alerts may include operational alerts, maintenance alerts, and other notifications relating to the operation and health of the equipment. Other alerts may also include time threshold or financial threshold alerts that may be sent in such cases as when an operator has been at a site for more than a predetermined amount of time or has reached the budget limit for the site. Further alerts may also be included and are described further herein. The system may also provide reports including, but not limited to, profitability, efficiency, and runtime reports as described further below. These reports may be contemporaneous or non-contemporaneous.

An example implementation may be described as follows. A lawn care and landscape company employs multiple operators (e.g., users) to provide services for a set of baseball fields. The operators use lawnmowers (e.g., connected units) to cut the grass on the baseball fields according to a schedule. For example, each individual operator is tasked to mow one of the baseball fields. Various issues can arise during the performance of such a task, including, but not limited to, operational and maintenance issues (e.g., engine overheating, low oil, low fuel, etc.), inefficient productivity, scheduling issues, bad weather, and theft of equipment. A user interface on an enterprise computing system (e.g., cloud-based system) is used to monitor these types of issues. The display of the user interface may indicate that a particular operator is not working as efficiently as other operators. Through use of a fleet management system, the lawn care company can take action regarding that individual operator to improve performance of the overall fleet. As a further example, it may be determined that a particular lawnmower may require maintenance in the near future. This may be determined based off of parameters read from the sensors on that lawnmower and relayed to the enterprise computing system to be displayed on the user interface. In this example, the lawn care company can use this data to proactively manage operators, maintain equipment, determine profitability margins and efficiency, and lessen the impact of equipment downtime.

Another example implementation may be described as follows. A salt spreading company employs multiple operators to provide salt spreading services for a set of parking lots. The operators use salt spreaders (e.g., connected units) to evenly distribute salt over the parking lot surfaces. Each individual operator may be tasked to salt a specific lot or portion of a lot. Various issues can arise if the salt spreaders are not managed during the performance of such a task including inefficient productivity (including over-salting, under-salting, repeat applications, etc.), profitability issues, operational and maintenance issues, scheduling issues, and theft of equipment. A user interface on an enterprise computing system can be used to monitor these issues. For example, the display of the interface may indicate that one of the operators is applying too much salt (e.g., by determining that the weight of the spreader is decreasing too rapidly) or may indicate that the salt is being applied too quickly (e.g., by determining the speed of rotation of the spreader as compared to the speed of the spreader vehicle). In this example, the salt spreading company can use this data to proactively and reactively manage operators, maintain equipment, determine profitability margins and efficiency, and lessen the impact of equipment downtime.

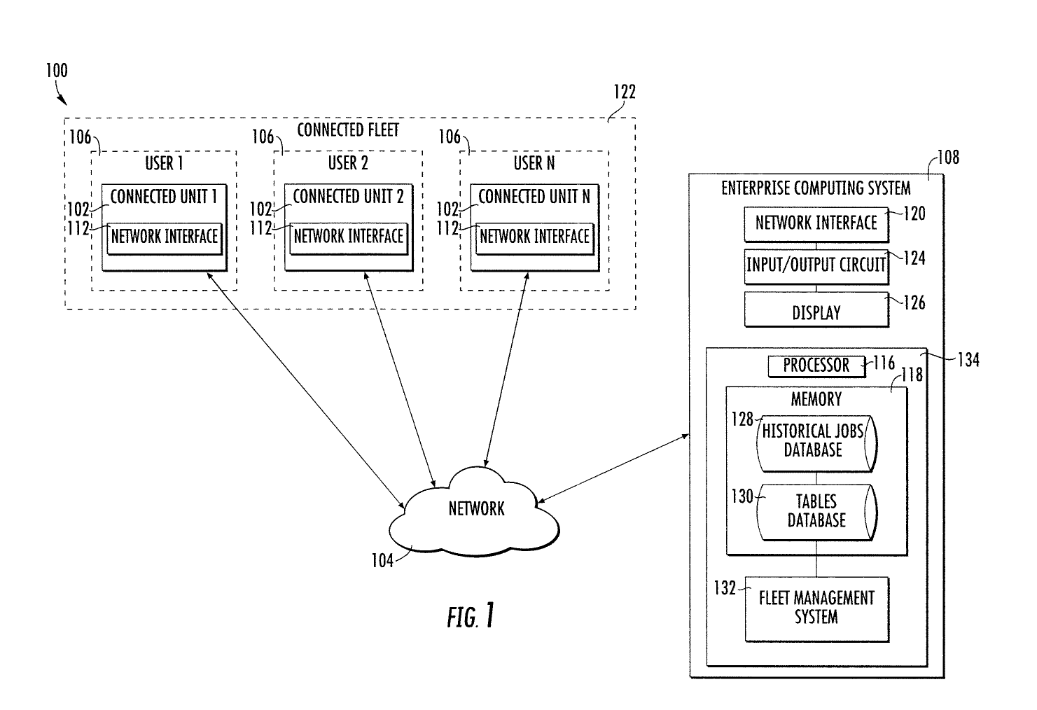

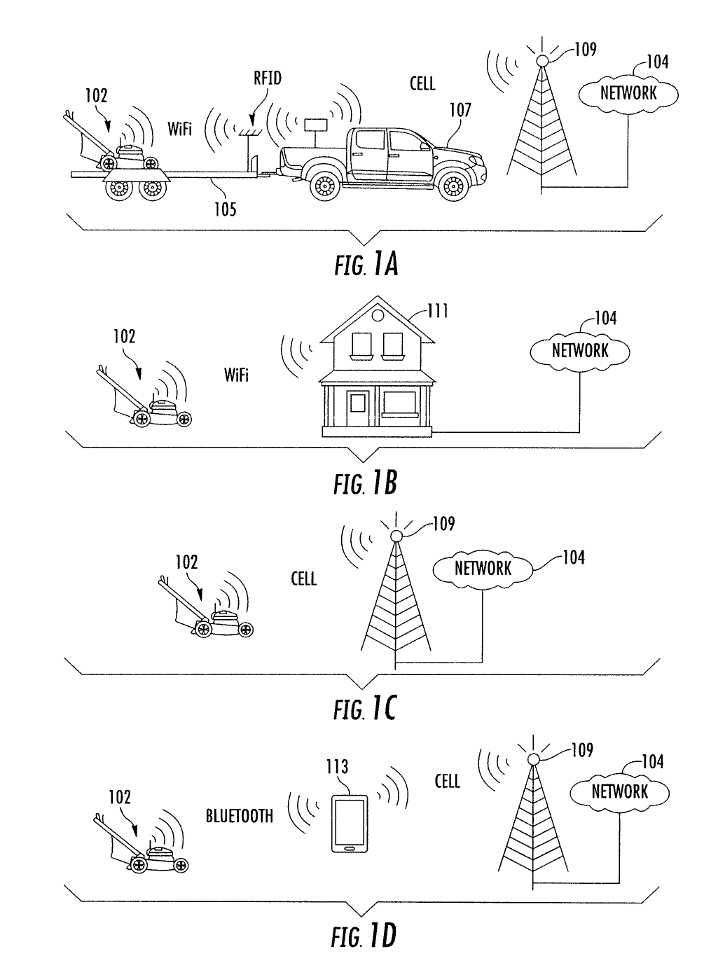

Referring to FIG. 1, an environment for managing outdoor power equipment is shown according to an exemplary embodiment. As described in further detail below, the environment 100, including the systems and methods therein, facilitates management of outdoor power equipment. The environment 100 includes one or more connected units 102 connected to a network 104. The connected units 102 are used by one or more users 106. An enterprise computing system 108 is also connected to the network 104. In some arrangements, the users 106 communicate over the network 104 to the connected units 102 and to the enterprise computing system 108 via user devices, such as smartphones, laptop computers, desktop computers, tablet computers, and the like. In some arrangements, the enterprise computing system 108 communicates to the users 106 and the connected units 102 over the network 104.

As used herein, “connected unit” refers to an individual piece of outdoor power equipment and “connected fleet” refers to more than one piece of outdoor power equipment. Outdoor power equipment includes lawn mowers, riding tractors, snow throwers, pressure washers, portable generators, tillers, log splitters, zero-turn radius mowers, walk-behind mowers, riding mowers, industrial vehicles such as forklifts, utility vehicles, etc. Outdoor power equipment may, for example use an internal combustion engine to drive an implement, such as a rotary blade of a lawn mower, a pump of a pressure washer, the auger of a snow thrower, the alternator of a generator, and/or a drivetrain of the outdoor power equipment.

As shown, the environment 100 depicts multiple users (e.g., user 1, user 2, etc.) and multiple connected units (e.g., connected unit 1, connected unit 2, etc.). This depiction is for illustrative purposes only to show an implementation environment of the systems and methods described herein. Each of these entities may have the same or similar characteristics. For the purpose of clarity, the disclosure contained herein is in reference to a single user and a single connected unit. In some embodiments, individual users 106 each operate respective connected units 102 which together form a connected fleet 122.

As shown, the connected unit 102 includes a network interface 112. In some arrangements, the network interface 112 includes the hardware and logic necessary to communicate over multiple channels of data communication. For example, the network interface 112 may include a Wi-Fi interface, a cellular modem, a Bluetooth transceiver, a Bluetooth beacon, a (radio-frequency identification (RFID) transceiver, a near-field communication (NFC) transceiver, or a combination thereof. The network interface 112 facilitates data communication to and from the connected unit 102. In some arrangements, data passing through the network interface 112 is encrypted such that the network communication is secure.

In the environment 100, data communication between the connected unit 102, the user 106, and the enterprise computing system 108 in various combinations may be facilitated by the network 104. In some arrangements, the network 104 includes cellular transceivers. In another arrangement, the network 104 includes the Internet. In yet another arrangement, the network 104 includes a local area network or a wide area network. The network 104 may be facilitated by short and/or long range communication technologies including Bluetooth transceivers, Bluetooth beacons, RFID transceivers, NFC transceivers, Wi-Fi transceivers, cellular transceivers, wired network connections, etc. As such, in one embodiment, the enterprise computing system 108 can be facilitated by and connected to a cloud-based system via RFID and Wi-Fi connections on the equipment, trucks, and trailers. In another embodiment, the enterprise computing system 108 can be facilitated by and connected to a cloud-based system via Wi-Fi only. In another embodiment, the enterprise computing system 108 can be facilitated by and connected to a cloud-based system via cellular transceivers. In yet another embodiment, the enterprise computing system 108 can be facilitated by and connected to a cloud-based system via Bluetooth and cellular transceivers. In still another embodiment, the enterprise computing system 108 can be facilitated by and connected to a cloud-based system and used with a self-vending system with which customers can interact to rent equipment. In all such embodiments, the cloud-based system can be made accessible to a third party, such as a consumer, dealer, and fleet operator. In some embodiments, the enterprise computing system 108 can additionally be connected to external third party computing systems for integrated use of those systems.

Various machine-to-machine (“M2M”) communication systems can be implemented to connect a connected unit 102 to the network 104. FIGS. 1A-1D illustrate exemplary M2M communication systems. In FIG. 1A, a pair of connected units 102 communicate with a trailer or transport 105 via RFID to identify which connected units 102 are paired with which transport 105. The connected units 102 communicate with a vehicle 107 (e.g., a truck) via WiFi and the vehicle communicates with a cellular tower 109 via cellular communications. The cellular tower 109 communicates with the network 104. In FIG. 1B, a connected unit 102 communicates via WiFi with a WiFi unit located in a building 111 (e.g., home, business, dwelling, etc.). The WiFi unit communicates with the network 104. In FIG. 1C, a connected unit 102 communicates with a cellular tower 109 via cellular communications. The cellular tower 109 communicates with the network 104. In FIG. 1D, a connected unit 102 communicates with a mobile device 113 (e.g. phone, tablet, laptop computer, etc.) via Bluetooth and the mobile device 113 communicates with a cellular tower 109 via cellular communications. The cellular tower 109 communicates with the network 104.

As noted above, in some arrangements, the vehicle 107 receives communication from the connected units 102 via WiFi and the vehicle 107 communicates that information to a cellular tower 109 via cellular communication. Other types of data communication between the unit 102, vehicle 107, and network 104 may occur. The vehicle 107 communicates with connected unit 102 information such that each connected unit 102 that does not include an energy storage device capable of supporting communication over long distances (e.g., several miles) may transmit communications to the vehicle 107, which then acts as a gateway for communication between the unit 102 and the network 104.

In some arrangements, the user 106 is in communication with the enterprise computing system 108. Users 106 are individuals, companies, corporations, or other entities that use the connected units 102 directly or indirectly. The enterprise computing system 108 is associated with an entity managing the fleet of outdoor equipment (e.g., connected fleet 122).

The enterprise computing system 108 includes any type of computing device that may be used to facilitate management of outdoor power equipment. The enterprise computing system 108 may include any wearable and non-wearable device. Wearable devices refer to any type of device that an individual wears including, but not limited to, a watch (e.g., smart watch), glasses (e.g., eye glasses, sunglasses, smart glasses, etc.), bracelet (e.g., smart bracelet), etc. The enterprise computing system 108 may also include any type of mobile device including, but not limited to, a phone (e.g., smart phone, etc.) and/or computing devices (e.g., desktop computer, laptop computer, personal digital assistant, etc.).

The enterprise computing system 108 includes a network interface 120, which is used to establish connections with other components of the environment 100 by way of network 104. The network interface 120 includes program logic that facilitates connection of the enterprise computing system 108 to the network 104. The network interface 120 supports communication between the enterprise computing system 108 and other systems, such as the connected unit 102. For example, the network interface 120 includes a cellular modem, a Bluetooth transceiver, a Bluetooth beacon, an RFID transceiver, and an NFC transmitter. In some embodiments, the network interface 120 includes the hardware and machine-readable media sufficient to support communication over multiple channels of data communication. Further, in some arrangements, the network interface 120 includes cryptography capabilities to establish a secure or relatively secure communication session with the enterprise computing system 108 and connected unit 102.

The enterprise computing system 108 further includes a display 126 and an input/output circuit 124. The display 126 is used to present operational data, route and/or location information, productivity information, and the like on the enterprise computing system 108. In this regard, the display 126 is communicably and operatively coupled to the input/output circuit 124 to provide a user interface for receiving and displaying information on the enterprise computing system 108. Examples of user interfaces are described more fully herein with regard to FIGS. 4-7.

The input/output circuit 124 is structured to receive and provide communication(s) to a user (e.g., a fleet manager) of the enterprise computing system 108. In this regard, the input/output circuit 124 is structured to exchange data, communications, instructions, etc. with an input/output component of the enterprise computing system 108. Accordingly, in one embodiment, the input/output circuit 124 includes an input/output device such as a display device, a touchscreen, a keyboard, and a microphone. In another embodiment, the input/output circuit 124 may include communication circuitry for facilitating the exchange of data, values, messages, and the like between an input/output device and the components of the enterprise computing system 108. In yet another embodiment, the input/output circuit 124 may include machine-readable media for facilitating the exchange of information between the input/output device and the components of the enterprise computing system 108. In still another embodiment, the input/output circuit 124 may include any combination of hardware components (e.g., a touchscreen), communication circuitry, and machine-readable media.

The enterprise computing system 108 further includes a historical jobs database 128. The historical jobs database 128 is configured to hold, store, categorize, and otherwise serve as a repository for information related to past archived jobs. When referred to herein, “jobs” include any instance of employment of one or more connected fleets 122 to perform a task, which may or may not be in exchange for money. Further, information regarding past jobs may include job location and any equipment, staffing, and scheduling logs for those jobs. In some arrangements, the historical jobs database 128 stores only information about past jobs for a certain connected fleet 122. In other arrangements, the historical jobs database 128 stores all information related to multiple connected fleets 122. In this regard, multiple connected fleets 122 may be monitored at once.

The enterprise computing system 108 further includes a tables database 130. The tables database 130 is configured to hold, store, categorize, and otherwise serve as a repository for various information relating to the connected unit 102. For example, the tables database 130 provides access to one or more expected (e.g., normal, predetermined) operational parameters for the connected unit 102. Additionally, the tables database 130 provides access to information relating to expected geographic location information (e.g., geo-fencing, predetermined route) of the connected unit 102.

As used herein, “operational parameters” include, but are not limited to, angle of operation, acceleration, air/fuel mixing device data (e.g., electronic fuel injection (EFI) data, carburetor sensor data), power takeoff switch status, spark plug signal, one or more indicator lights, air cleaner pressure, low oil pressure, tire pressure, air temperature, oil temperature, auxiliary temperature, and so on. In some embodiments, the operational parameters include ranges with a maximum and minimum desired value to which a current operating parameter of the connected unit 102 can be compared.

The enterprise computing system 108 includes a fleet management system 132 for managing a fleet of connected units 102. The fleet management system 132 is structured to receive data from various sensors of the connected unit 102, as well as data from the historical jobs database 128 and tables database 130 to generate a display on the user interface of the enterprise computing system 108. In some embodiments, the fleet management system 132 uses the received data to generate an alert. The fleet management system 132 may compare the received data to operational parameters stored in the tables database 130 to determine that an alert needs to be generated. In some arrangements, the fleet management system 132 is configured to generate a message for display on the enterprise computing system 108 alerting of abnormal operating conditions. Further, in some arrangements, the fleet management system 132 is configured to transmit a message for display on a user device of the user 106 reflecting recommendations for further action. The fleet management system 132 will be discussed in more detail with regard to FIG. 3.

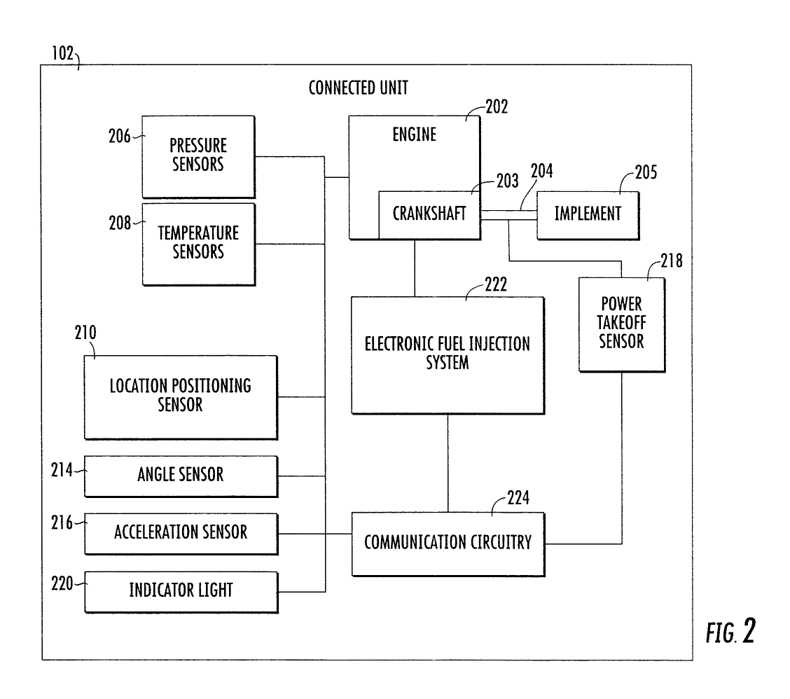

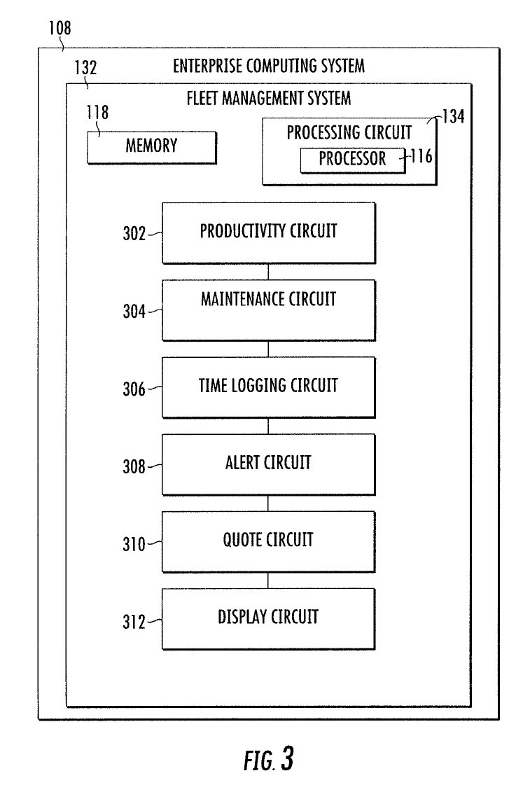

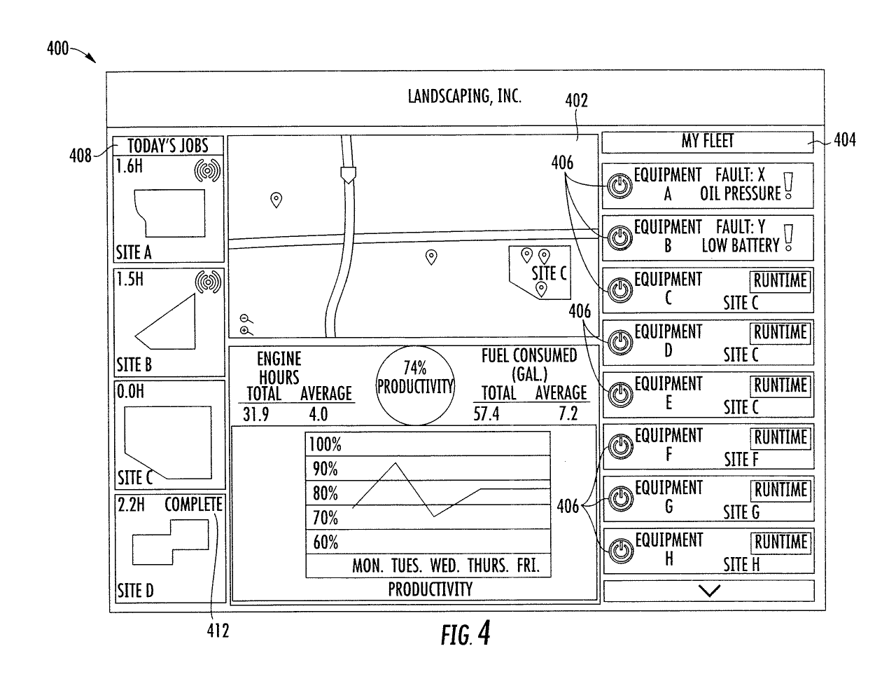

Referring now to FIG. 2, a diagram of a connected unit 102 is shown, according to an exemplary embodiment. The connected unit 102 is shown to include a prime mover shown as an engine 202, a crankshaft 203, a power takeoff 204, and an implement 205 (e.g., mower blade, pump, auger, tiller, alternator, brush, log-splitter, sprayer, salter, etc.). The prime mover can include an internal combustion engine or an electric motor powered by a battery (e.g., removable, replaceable lithium-ion battery). In the case of an electric motor, a charging station for the battery can be included with and/or stored on the vehicle 107 used to transport the connected unit 102. The battery is removably inserted into the charging station to be charged during times when the connected unit 102 is not in use. On connected units 102 with an electric motor as the prime mover, operational data such as battery use, voltage level, current draw, motor currents, fault conditions, charging setting, and charging function, etc., may be monitored in addition to the other operational data described herein.

The connected unit 102 additionally includes various sensors including a power takeoff sensor 218, one or more pressure sensors 206, one or more temperature sensors 208, a location positioning sensor 210, an angle sensor 214, an acceleration sensor 216, an indicator light 220, an electronic fuel injection (EFI) system 222, and communication circuitry 224. In one embodiment, the connected unit 102 includes a carburetor with various sensors to detect data relating to the air/fuel mixing operation. In another embodiment, the connected unit 102 includes a fuel delivery injection system.

In some embodiments, the implement 205 is coupled to the power takeoff 204 of the engine 202, which is driven by the crankshaft 203. The power takeoff sensor 218 is coupled to the power takeoff 204 to determine when the power takeoff is operating. In some embodiments, the power takeoff sensor 218 may be a switch configured to detect the state (e.g., engaged or disengaged) of the power takeoff shaft. The power takeoff sensor 218 is additionally configured to relay this information to the communication circuitry 224 to be transmitted to the enterprise computing system 108. In this regard, the power takeoff sensor 218 is communicably and operatively coupled to the power takeoff 204 and to the communication circuitry 224.

The pressure sensors 206 are configured to detect a pressure of various components of the connected unit 102. For example, some pressures that may be measured include the air cleaner pressure, oil pressure, and manifold pressure. In other arrangements, manifold pressure is measured through use of the EFI system 222. In some embodiments, the pressure sensors 206 include oil pressure gauges that include a switch which activates at low oil pressures. In this embodiment, the oil pressure gauges may be coupled to the indicator light 220 to indicate low oil pressure when the switch on the gauge is activated. In other embodiments, the pressure sensors 206 include differential pressure sensors to measure the pressure drop across an air cleaner, where the pressure drop may be used to detect a dirty air filter that needs to be replaced. In some other embodiments, the pressure sensors 206 include manifold absolute pressure (MAP) sensors. The pressure sensors 206 relay pressure information to the communication circuitry 224 to be transmitted to the enterprise computing system 108. In this regard, the pressure sensors 206 are communicably coupled to the communication circuitry 224.

Similarly, the temperature sensors 206 are configured to sense a temperature of the engine 202 and various components of the engine 202 in the connected unit 102. For example, some temperatures that may be measured include the oil temperature, intake air temperatures, and exhaust manifold temperatures. In other arrangements, exhaust header temperatures and intake air temperatures are measured through use of the EFI system 222. In some embodiments, the temperature sensors 206 include an engine coolant temperature sensor that measures the temperature of the engine coolant and in turn, may use that temperature measurement to determine a temperature of the engine 202. In other embodiments, the temperature sensors 206 include a sensor located at or near the engine 202, or a component thereof, to determine a temperature of the engine 202. In some other embodiments, the temperature sensors 206 include a sensor located in the environment in which the engine 202 is located to determine the ambient temperature of that environment. The temperature sensors 206 are communicably coupled to the communication circuitry 224 to transmit the sensed temperature information to the enterprise computing system 108 via the network 104.

The connected unit 102 additionally includes a location positioning sensor 210. The location positioning sensor 210 is structured to receive location data and determine a location or receive information indicative of a location of the connected unit 102. In one embodiment, the location positioning sensor 210 includes a global positioning system (GPS) or any other type of location positioning system. As such, the location positioning sensor 210 may receive latitude data, longitude data, and any other type of location or position data to determine the location of the connected unit 102. In other embodiments, the location positioning sensor 210 receives location data from the enterprise computing system 108 that indicates the location of the connected unit 102. In still other embodiments, the location positioning sensor 210 receives an explicit location identification from the user 106 of the connected unit 102. In further embodiments, the location positioning sensor 210 communicates information about a connected unit 102 outside of a predetermined (e.g., geo-fenced) area. For example, the location positioning sensor 210 may be used to determine that a connected unit 102 has been stolen if it is outside a predetermined area and/or may be used to determine the location of a unit 102 that is already known to be stolen. In some embodiments, the location data can include historical location data tracking the movement of the unit 102. In some embodiments, location positioning can additionally be used for a trailer and vehicle (e.g., vehicle 107) that are used to haul the connected unit 102. All such variations are intended to fall within the spirit and scope of the present disclosure.

The angle sensor 214 and the acceleration sensor 216 are structured to sense physical information regarding the connected unit 102. The angle sensor 214 senses the physical orientation of the connected unit 102 as it is in operation. In some embodiments, the angle sensor 214 includes a gyroscope to detect the angle of operation of the connected unit 102. In other embodiments, the angle sensor 214 includes any sensor suitable to sense the angle of operation of the connected unit 102.

The acceleration sensor 216 senses the acceleration and/or deceleration of the connected unit 102. In one embodiment, the acceleration sensor 216 is an accelerometer on the connected unit 102. In another embodiment, the acceleration sensor 216 is coupled to one or more wheels of the connected unit 102 to detect the speed of the unit 102. In yet another embodiment, the acceleration sensor 216 is coupled to the drive shaft of the connected unit 102 to detect the speed of the unit 102. In this regard, the acceleration sensor 216 can additionally detect that the unit 102 has impacted an object due to the deceleration of the unit 102. Both the angle sensor 214 and the acceleration sensor 216 are configured to communicate the physical information to the communication circuitry 224 to be transmitted to the enterprise computing system 108.

The acceleration sensor 216 can also detect whether the unit 102 is moving due to being transported or due to operation based on data from the acceleration sensor 216. For example, if the operational data from the unit 102 indicates that the unit 102 is not in operation (e.g., engine 202 is off) and the acceleration sensor 216 data indicates that the unit 102 is moving, then the system 132 determines that the unit 102 is being transported between jobsites.

The indicator light 220 is configured to indicate malfunctions of the connected unit 102. In some embodiments, the indicator light 220 is a check engine light where when lit, stores a fault code related to any malfunction detected with the engine 202. In this case, a scan tool can be used for further diagnosis of the malfunction. In some embodiments, when the connected unit 102 is used in connection with the enterprise computing system 108 as shown in the environment 100 of FIG. 1, the malfunction information is communicated directly to the enterprise computing system 108 via the network 104. In this regard, the indicator light 220 is communicably and operatively coupled to the communication circuitry 224.

The EFI system 222 is configured to measure various pressures, temperatures, and other data from the connected unit 102. For example, the EFI system 222 can measure fuel consumption, engine speed, blade speed, engine load, engine runtime, battery charge, exhaust header temperature, intake air temperature, and manifold pressure. All such data is communicated to the enterprise computing system 108 for use in the fleet management system 132.

The communication circuitry 224 is structured to notify the fleet management system 132 of all sensed values of the connected unit 102. In one embodiment, the communication circuitry 224 includes various hardware components, such as a transmitter, to send one or more values to the fleet management system 132. The transmitter facilitates the sending of information to the fleet management system 132 via the network 104. In another embodiment, the communication circuitry 224 includes wired and wireless communication protocol to facilitate transmission of the status of the connected unit 102 to the fleet management system 132. In still another embodiment, the communication circuitry 132 includes machine-readable media stored by the memory and executable by the processor, wherein the machine-readable media supports communication between the connected unit 102 and the fleet management system 132, facilitating transmission of the status by the communication circuitry 224. In yet another embodiment, the communication circuitry 224 includes any combination of a hardware components (e.g., a transmitter) and machine-readable content.

Communication is provided via any type of transmission method. In this regard, the communication may be provided as a continuous data stream to the enterprise computing system 108 such that a real-time display of the data is provided on a user interface as shown in FIGS. 4-7. In other embodiments, a text message, email, and/or an alert may be generated and provided to the fleet management system 132. The communication may be based on the identity or level of authorization of a user of the enterprise computing system 108. In this regard, a user of the enterprise computing system 108 may be required to enter credentials to access the fleet management system 132 and the user interfaces described in FIGS. 4-20. All such variations are intended to fall within the scope of the present disclosure.

Referring now to FIG. 3, a diagram of the fleet management system 132 and part of the enterprise computing system 108 is shown, according to an exemplary embodiment. As shown, the enterprise computing system 108 includes a processing circuit 134 having a processor 116 and a memory 118. The processor 116 may be implemented as a general-purpose processor, an application specific integrated circuit (ASIC), one or more field programmable gate arrays (FPGAs), a digital signal processor (DSP), a group of processing components, or other suitable electronic processing components. The one or more memory devices 118 (e.g., RAM, NVRAM, ROM, Flash Memory, hard disk storage, etc.) may store data and/or computer code for facilitating the various processes described herein. Moreover, the one or more memory devices 118 may be or include tangible, non-transient volatile memory or non-volatile memory. Accordingly, the one or more memory devices 118 may include database components, object code components, script components, or any other type of information structure for supporting the various activities and information structures described herein.

The fleet management system 132 may be embodied with the enterprise computing system 108. Accordingly, in some arrangements, the fleet management system 132 may be embodied or at least partly embodied in the memory 118, where at least some operations may be executable from the processing circuit 134. As described above, the fleet management system 132 facilitates management of a connected fleet 122 (e.g., one or more connected units 102). In some embodiments, the fleet management system 132 determines when the operating data received from physical sensors, as described above, on the connected unit 102 is outside of a normal operating range. The fleet management system 132 additionally facilitates management of job scheduling, staffing, and loss prevention for the connected units 102.

The fleet management system 132 is shown to include a productivity circuit 302, a maintenance circuit 304, a time logging circuit 306, an alert circuit 308, a quote circuit 310, and a display circuit 312, with all such circuits communicably coupled to each other. Other embodiments may include more or less circuits without departing from the spirit and scope of the present disclosure. Further, some embodiments may combine the activities of one circuit with another circuit to form a single circuit. Therefore, those of ordinary skill in the art will appreciate that the present arrangement is not meant to be limiting.

The productivity circuit 302 is structured to receive information from the connected unit 102. The information may include a runtime of the unit 102, or one or more physical components on the connected unit 102. The information may also include location of the unit 102 and as such, can also include the on-site time of the unit 102. When referred to herein, the “on-site time” includes, but is not limited to, the amount of time the unit 102 is at a particular jobsite. As such, the on-site time can include the amount of time the unit 102 is within a predetermined boundary designating the jobsite. The predetermined boundary or predetermined area can be preset in various ways. As an example, the predetermined boundary can be designated as a center point and radius by either a user of the system 100 or a customer. As another example, the predetermined boundary can be set by a user or customer inputting a drawn boundary into the system 100.

The productivity circuit 302 is additionally structured to receive information (e.g., various runtime data) from the historical jobs database 128 regarding past jobs of the connected unit 102. Using this data, the productivity circuit 302 determines the productivity of a particular connected unit 102 and thus, additionally determines the productivity of the user 106 of that unit 102. The productivity circuit 302 is additionally configured to receive information from the historical jobs database 128 to identify historical job locations and determine scheduling, equipment adjustments, and/or staffing adjustments to one or more jobs in view of the historical information related to those jobs.

The productivity circuit 302 is additionally structured to use information received from the historical jobs database 128 regarding past jobs performed (which may include the location of the jobs) and information regarding the profit margin from that job to associate the profit with the type of job that was performed. For example, if a particular job required very little elevation change for equipment, it may have a higher profit margin than jobs that require more elevation change. As another example, jobs that cover a large area of land may be less profitable than those covering a relatively small area.

As an example of productivity information, the productivity circuit 302 determines productivity based at least in part on values from the engine 202 runtime and the operator and/or unit on-site time. As noted above, the on-site time may be determined by the amount of time a unit 102 is within a predetermined boundary associated with the jobsite. Further, the on-site time may be determined by the amount of time a specific operator or an operator's mobile device is within the predetermined boundary. Accordingly, the productivity circuit 302 is communicably and operatively connected to the location positioning sensor 210 to receive location data of the connected unit 102 and a mobile device 113 of the operator. In one arrangement, the engine runtime is divided by the unit on-site time to determine an efficiency or productivity value expressed as a percentage. In another arrangement, the engine runtime is divided by the operator on-site time to determine the efficiency value. In some arrangements, efficiency values may be calculated on a rolling basis as the job is being completed such that the on-site time can include an ongoing time value. In other arrangements, the efficiency value is calculated after completion of a job such that the on-site time can include a completed time value. This efficiency value may be compared with other operator efficiencies, other crew efficiencies, efficiencies of the operator at other sites, efficiencies of the operator using different equipment, etc.

As another example of productivity information, the productivity circuit 302 may determine productivity based on runtime of a power takeoff. For instance, in one arrangement, the runtime of the power takeoff is divided by the engine runtime to determine productivity value expressed as a percentage. Another example of productivity information that may be displayed by the fleet management system 132 is staffing and scheduling requirements. Staffing and scheduling requirements include the need to hire more operators for particular jobs, the need to move around existing operators to distribute the operators where work is needed, and the need for schedule adjustments. As a further example, the productivity information can include which type of equipment is more efficient for which types of jobs, such as a walk behind being more efficient than a zero-turn radius mower when there are hills at a jobsite. Furthermore, the productivity information can include the cost of using and operating particular equipment including, but not limited to, labor, parts and maintenance.

As another example of productivity information, the productivity circuit 302 determines the completeness of a particular job. This can be used, for example, when a client calls with an urgent request for service and the fleet management system 132 determines which connected fleet of units 122 has bandwidth to take on another job immediately. Furthermore, the productivity information can include a comparison of the estimated time (e.g., quoted time) to complete a job versus the actual time to complete a job. In some arrangements, when the estimated time has been exceeded, the productivity circuit 302 communicates with the alert circuit 308 to notify the fleet management system 132 of the exceeded time limit. Along with the operational time, the equipment, job site, and operator information relating to that specific job can be tracked and stored in the memory 118 of the system 132. As such, the system 132 can identify the reason a particular job has exceeded an allotted time limit.

The productivity circuit 302 is further configured to communicate the productivity data to the display circuit 312. In this regard, in one embodiment, the productivity circuit 302 is communicably and operatively coupled to the connected unit 102 to receive information regarding the unit 102 and to the historical jobs database 128 to receive historical information regarding the unit 102. In further embodiments, the productivity circuit 302 is additionally communicably and operatively coupled to the display circuit 312 to communicate the productivity information to the display circuit 312 for display on a user interface, as described further herein with relation to FIGS. 4-20.

The maintenance circuit 304 is structured to receive information from the EFI system 222 (e.g., engine runtime, engine load), the pressure sensors 206, and the temperature sensors 208 from the connected unit 102. In some embodiments, the maintenance circuit 304 additionally receives information from the indicator light 220. The maintenance circuit 304 additionally receives information from the historical jobs database 128 including a maintenance schedule of the connected unit 102 to determine a time in the future when maintenance may be necessary. In some arrangements, the maintenance circuit 304 communicates with the display circuit 312 to display a message regarding maintenance of a particular unit 102. Thus, the maintenance circuit 304 is communicably coupled to the historical jobs database 128 and to the connected unit 102 to make maintenance determinations and to the display circuit 312 to display maintenance information. As an example, the maintenance circuit 304 uses information received from the EFI system 222, such as engine runtime, and information from the historical jobs database 128 to determine that a particular unit 102 requires maintenance based on how long the engine 202 of the unit 102 has run since last maintained.

As another example, the maintenance circuit 304 uses information received from the connected units 102 to identify the units 102 in need of maintenance and note that they need to be removed from service. In this regard, the maintenance circuit 304 may generate and send a message to the display circuit 312 to display the message indicating an identification of units 102 to be removed. In some embodiments, the fleet management system 132 interfaces with a dealer or maintenance personnel to either schedule maintenance work on the units 102 or removal of the units 102 (e.g., via email, text message).

As another example, after identifying units 102 in need of maintenance, the maintenance circuit 304, along with the productivity circuit 302, identifies a user 106 with a functional unit 102 that is ahead of schedule that could help out by replacing the faulty unit 102. In this regard, the maintenance circuit 304 may communicate with the productivity circuit 302 to facilitate redistribution of units 102 to cover down units 102.

As another example, the maintenance circuit 304 uses information about a unit 102 to determine that the unit 102 has been needing maintenance too frequently. As such, if a certain unit, known to be an older unit, is regularly undergoing necessary maintenance, the maintenance circuit 304 may indicate to the fleet management system 132 that the unit 102 needs to be replaced soon.

The time logging circuit 206 is structured to update and maintain a time log in the tables database 130. The time log indicates several time-related issues, including, but not limited to, the engine runtime, the power takeoff runtime, the specific dates and times when the unit 102 has been operated, the specific dates and times that a sensed value has been outside operating range, and so on. In this regard, the time logging circuit 206 is communicably coupled to each of the sensors shown in FIG. 2 to receive time information and to the tables database 130 to store the information received from the sensors. Furthermore, the time logging circuit 206 may track specific maintenance dates and services that are scheduled to be performed or have already been performed.

The alert circuit 308 is structured to communicate with the productivity circuit 302, maintenance circuit 304, and the time logging circuit 306 to receive an indication that a problem has occurred with the connected unit 102 and transmit a notification to the enterprise computing system 108 for display. In some embodiments, the problem is detected by comparing the values received from the connected unit 102 to the values stored in the table database 130. In this regard, the alert circuit 308 is communicably and operatively coupled to the tables database 130, the connected unit 102, and the display circuit 312 to provide a real-time alert for display on the enterprise computing system 108. In addition, the alert circuit 308 is configured to receive and transmit other alerts relating to the fleet including alerts relating to unit start, unit stop, geo-fence timing, unit in/out of geo-fence, after-hours activity, excessive unit speed, excessive unit idling, ignition on/off, crash detection, fuel theft detection, low battery, diagnostic trouble codes, proximity/reed sensing, landmark entry/exit, late starts, panic button detection, long route stops, temperature under/over, unit tampering, temperature ranges, towing detection, vibration sensing, jamming detection, battery disconnect, unauthorized use, hard braking, motion detection, time overages, fee overages, etc.

The quote circuit 310 is structured to determine a quote for a prospective job and/or client. The quote circuit 310 is structured to determine a quote based on various criteria, including, but not limited to, the acreage, elevation change, obstacles within the area, past quotes for similar jobs, and so on. In some embodiments, the quote circuit 310 uses information from the historical jobs database 128 to determine a quote. In other embodiments, the quote circuit 310 uses the Internet to determine an acreage, elevation, and other physical land data. In further embodiments, the quote circuit 310 uses a client-drawn map of the job area in determining a quote for that job. In this case, the client may use a user interface of the fleet management system 132 to electronically draw a route and/or boundary for the job. Quotes for each job site may be based on a cost per hour analysis based on the job site variables (e.g., physical land data, acreage, elevation) where a preset margin of profitability is built into the quote. The preset margin of profitability may be input as part of a cost input for a particular job. The user of the system may set a profitability margin based on the estimated cost of the job.

Furthermore, the quote circuit 310 is structured to determine invoicing for clients including, but not limited to, specifics regarding time needed to complete job, a flat fee for the job, and so on. In further embodiments, the quote circuit 310 is structured to determine internal payroll information for employees, such as determining a billable rate for each employee (e.g., for each jobsite) based on jobsite information and productivity statistics for each employee. Other payroll information can be determined based on time on the job site and time away from the central garage. In this regard, in some instances, the quote circuit 310 could be used to check for potential internal fraudulent activity.

The quote circuit 310 is also configured to monitor job status as the operator is completing a job. The quote circuit 310 can determine the current fee for the job, compare the current fee to the quoted fee and if the estimated fee is or will soon be exceeded, generate and transmit a message (e.g., via the alert circuit 308, display circuit 312) alerting the fleet management system 132 to the exceeded quote limit. In some arrangements, a margin of profitability is determined based on preset values. In this case, the quote circuit 310 can monitor the current fee against the fee with margin of profitability taken into consideration. In other arrangements, a user of the fleet management system 132 can preset an unrelated threshold fee value at which point the alert will be transmitted. In this way, along with the fee overage information, the equipment, job site, and employee information relating to that fee overage can also be monitored. As such, the system 132 can identify the reason a particular job is over budget.

The quote circuit 310 is further configured to automatically generate an invoice upon completion of a job. For example, the quote circuit 310 receives an indication from the location positioning sensor 210 that one or more units 102 have left the jobsite or that the units 102 are off, being transported, etc., and generates an invoice for the completion of the job. In some embodiments, the quote circuit 310 transmits the invoice directly to the customer. In other embodiments, the quote circuit 310 transmits a report of the invoice to a user (e.g., via the alert circuit, display circuit) of the system 132, such that the user may review the invoice prior to sending to the customer.

The display circuit 312 is structured to generate a message for display on the enterprise computing system 108 based on received communication from each of the circuits included with the fleet management system 132. In some embodiments, the display circuit 312 may also be structured to generate a message for display based on a level of authorization and/or the job title of the user of the enterprise computing system 108. For example, the display circuit 312 may display different information to users of differing access, rights, and privileges. The display circuit 312 displays various user interfaces as shown in FIGS. 4-20.

The display circuit 312 may create, generate, establish, update, and maintain a status list of one or more of the connected units 102 and/or one or more connected fleets 122 and any information associated therewith. Accordingly, in one embodiment, the display circuit 312 includes a list generating tool. In another embodiment, the display circuit 312 includes communication circuitry for facilitating the exchange of information between and among the display circuit 312 and any other circuitry or logic. In yet another embodiment, the display circuit 312 includes any combination of machine-readable media, list generating tool, and communication circuity. In some arrangements, the display includes a list of status information, wherein a user of the enterprise computing system 108 may observe or search the list for information associated with certain connected units 102. Information included in the list may include, but is not limited to, an identification of the connected unit 102 (e.g., designated name of unit, name of user) and a status of the unit 102 (e.g., operational, current runtime, outside geo-fenced area, etc.). In further embodiments, the information includes further instructions on possible next steps to fixing any problems with each unit 102. For example, if the connected unit 102 is outside the geo-fenced area (e.g., route, acreage), the information may include the current location of the connected unit 102.

In further embodiments, the display circuit 312 additionally includes a data export function that may export any and/or all of the data described herein to a spreadsheet either on the fleet management system 132 or may transmit the data to a separate accounting or invoicing system for display and/or editing. This data may include and/or be utilized to make various determinations including, but not limited to, fuel and labor cost estimating and tracking, if a unit is using a disproportionate amount of fuel, if too much overtime is being paid to a particular employee or all employees in general, if there is a demand for new employees, if new equipment is needed, if employees need to be relocated to other jobs, etc. In some embodiments, the display circuit 312 can additionally include an input function that receives data from an outside source. For example, a user can upload information to the enterprise computing system 108 for use with the system 100.

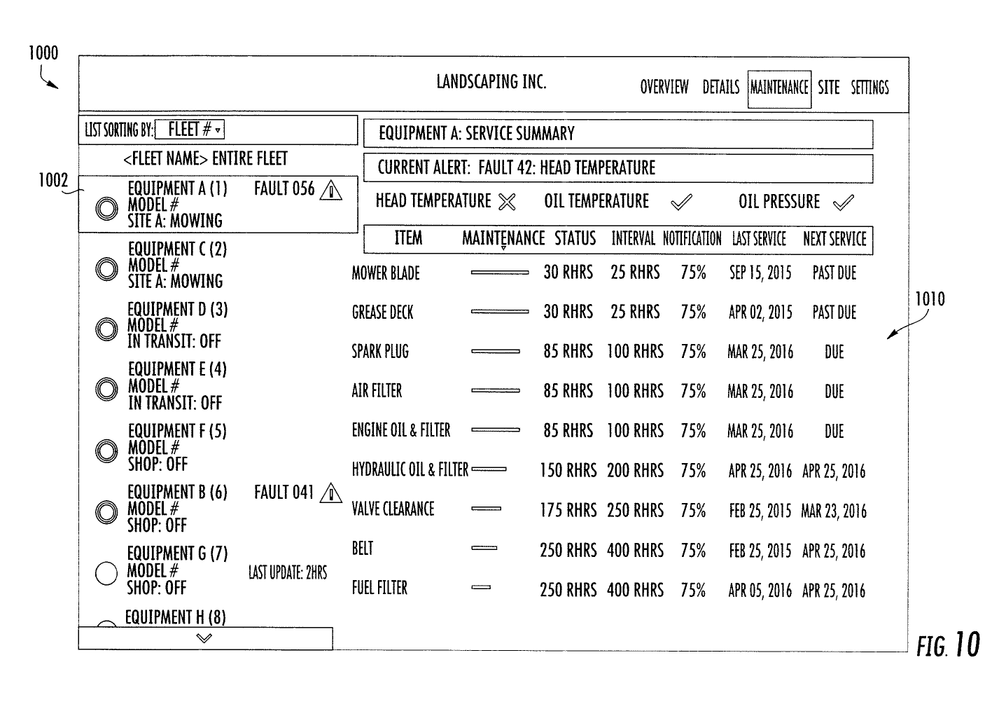

Referring to FIGS. 4-20, various example user interfaces are depicted. The user interfaces depicted in FIGS. 4-20 are used in connection with the system 100 and fleet management system 132 described in FIGS. 1-3. Accordingly, description of the user interfaces in FIGS. 4-20 may reference components of one or more of FIGS. 1-3. In FIG. 4, the user interface 400 displays a map 402 with location information of the connected units 102, along with a list 404 of the units 102. Both map 402 and list 404 views show whether there is a current problem with each unit and the list 404 view indicates the specific problem. The map 402 and list 404 views both indicate the current position of the units. For example, the unit 102 labeled “Equipment B” has “low battery voltage” and the unit “Equipment A” has a problem with oil pressure. Further, each unit 102 has a power symbol 406 indicating, by color, whether the unit 102 is currently turned on. On the left side of the interface, each job is mapped and detailed in a detailed view 408. For each job, a small map 410, current completion status 412, and runtime 414 are displayed. In another embodiment, the user interface shown in FIG. 8 is used to indicate similar information. In FIG. 8, the user interface 800 additionally includes dashed lines on the map 802 view indicating where the unit has traveled (e.g., historical location data) and/or the intended future path. Further, the list view indicates which crew number or name the unit currently belongs to and a fleet statistics graph 816 displaying toggle options 818 including options for displaying statistics relating to site hours, engine hours, mowing hours, fuel, and productivity. In other arrangements, more or less toggle options may be included.

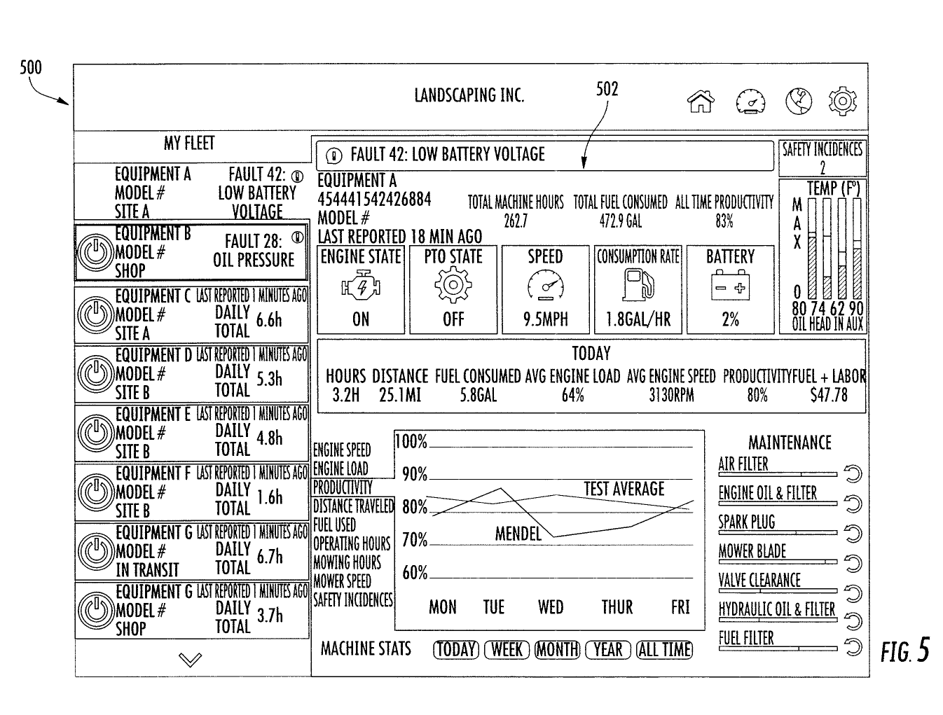

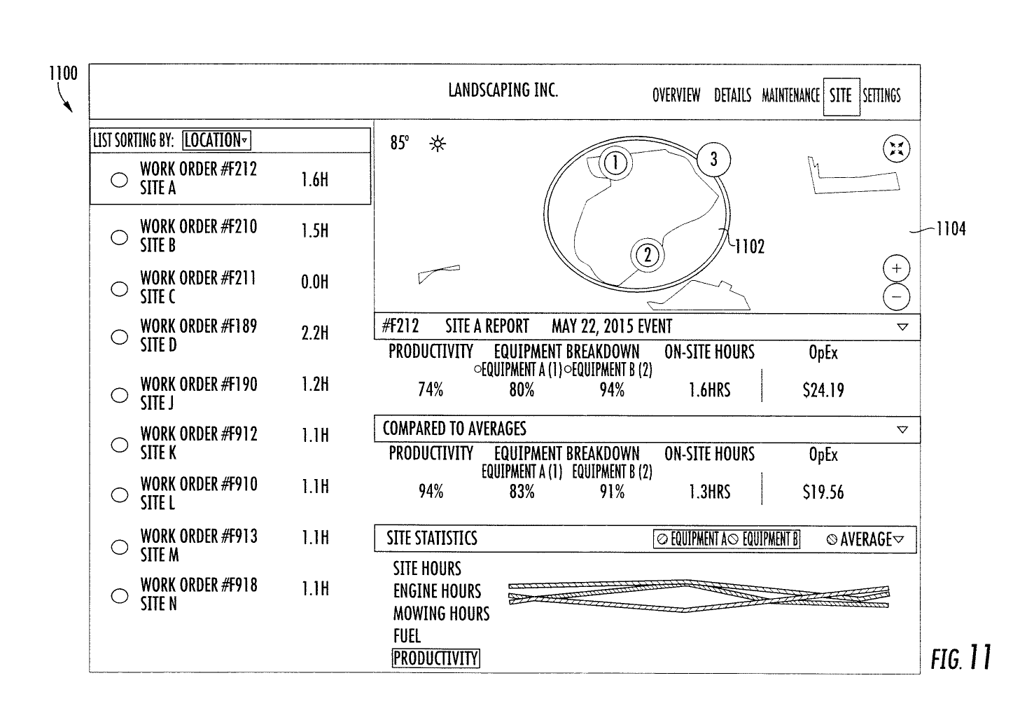

Turning to FIG. 5, the user interface 500 includes detailed information for a selected unit. For example, as shown in FIG. 5, the “Equipment B” unit has been selected and various operational parameters 502 are displayed for that particular unit, including productivity, engine state, power takeoff state, and so on. In another embodiment, the user interface 900 shown in FIG. 9 is used to indicate similar information. FIG. 9 further displays comparisons between the particular unit and the entire fleet average at comparison chart 910. Further, the user interface 1000 shown in FIG. 10 can be included showing similar information and additionally including information regarding specific components of particular selected units. For example, “Equipment A” unit is selected on the list view 1002 and in the component listing 1010 the components “mower blade,” “grease deck,” “spark plug,” and so on are displayed. For each component, various statistics are shown including next service date, last service date, maintenance indicators, and so on.

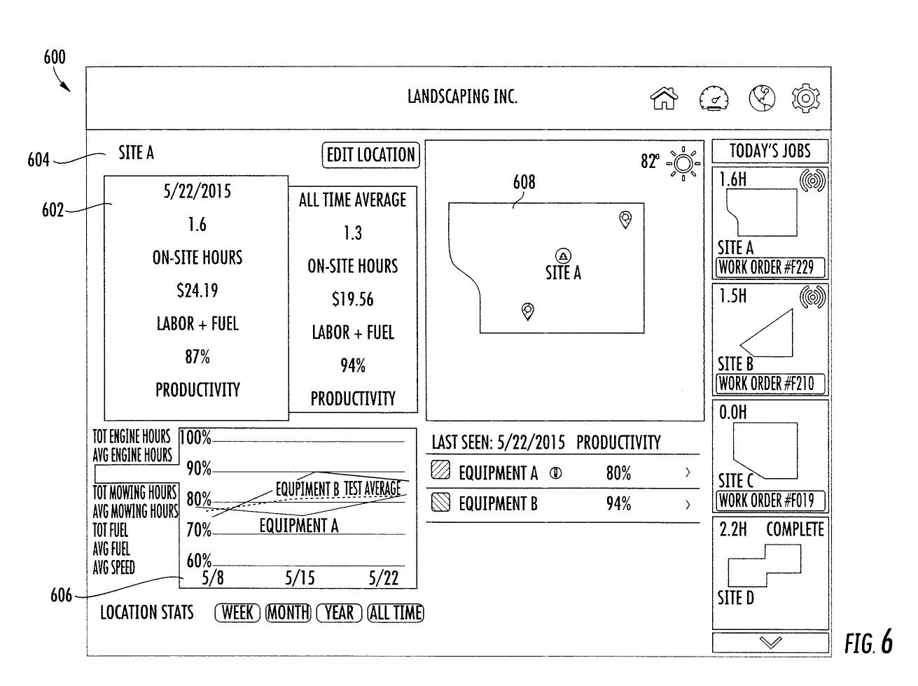

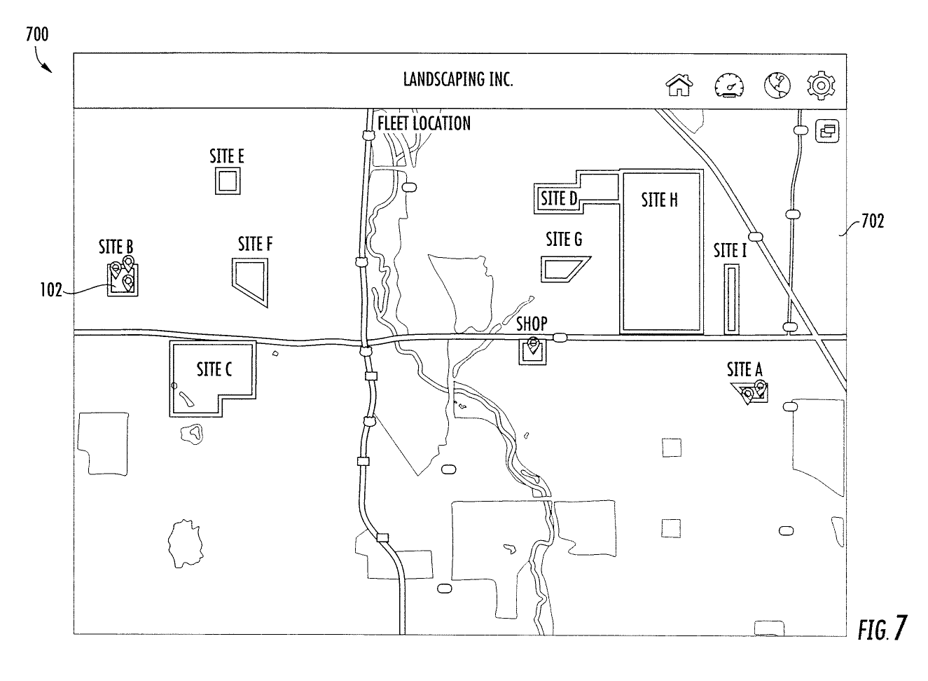

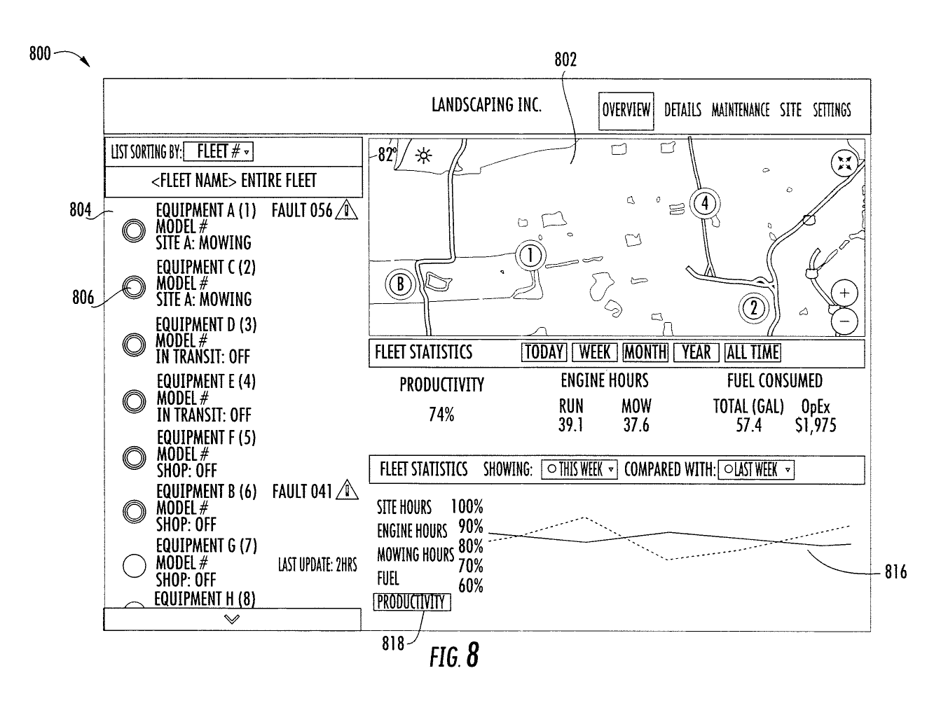

In FIG. 6, the user interface 600 displays detailed job information. The detailed job information 602 includes a specific jobsite 604 (e.g., Site A), the connected units on that job, and the specific location of the units within the job area on a map 608. The display additionally shows whether any problems with each unit are occurring and the productivity and operational data 606 of each unit, including a comparison of each unit to a test average. In another embodiment, the user interface shown in FIG. 11 is used to indicate similar information. FIG. 11 additionally shows a geo-zoned area 1102 on a map 1104. As noted above, the geo-zoned area can be preset by a user of the system 132 in various ways (e.g., drawing, setting a central point and radius).

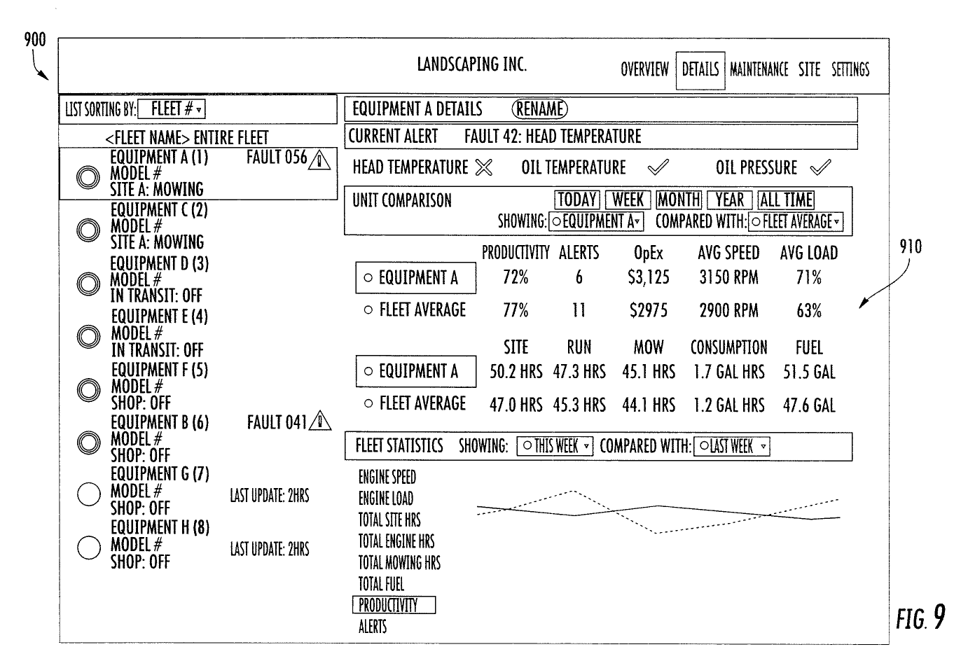

The user interface 700 shown in FIG. 7 displays an overall view of the jobs on an area of a map 702. The display may be zoomed in or out by the user to display more or less job sites. As shown, the job sites are outlined and the connected units within those sites are shown. This user interface 700 may be used to map specific areas for jobs with a map service (e.g., Google Maps). A user may set bounds for a quote, pull elevation change information from the map service, etc.

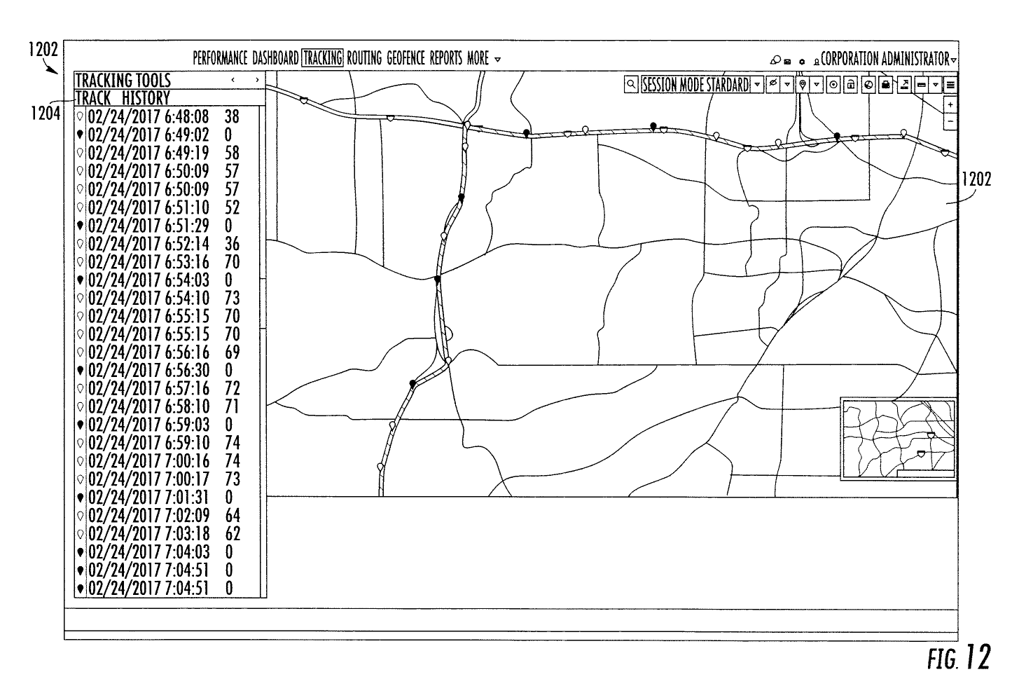

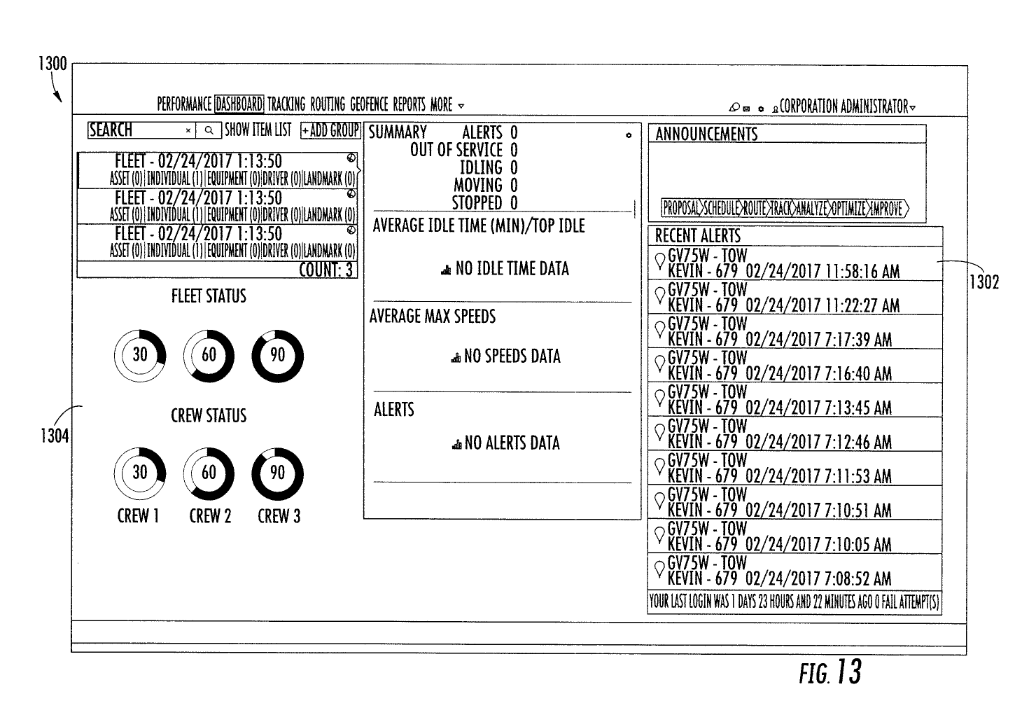

The user interface 1200 shown in FIG. 12 displays an example tracking screen. The tracking screen includes a map 1202 and a tracking history list 1204. The map 1202 displays the tracked history of a particular unit and the tracking history list 1204 indicates the time the unit was at a particular location.

The user interface 1300 shown in FIG. 13 displays a dashboard screen. Among other information, the dashboard screen includes a recent alerts list 1302 and a status display 1304. The recent alerts list 1302 includes information relating to the status of a particular crew and/or unit. As shown, the recent alerts list 1302 displays the status of the fleet as in “Tow” at various alert times. The time stamp shown indicates when such an alert was received by the system 132. The status display 1304 shows the progress of various crews for scheduled jobs for the day.

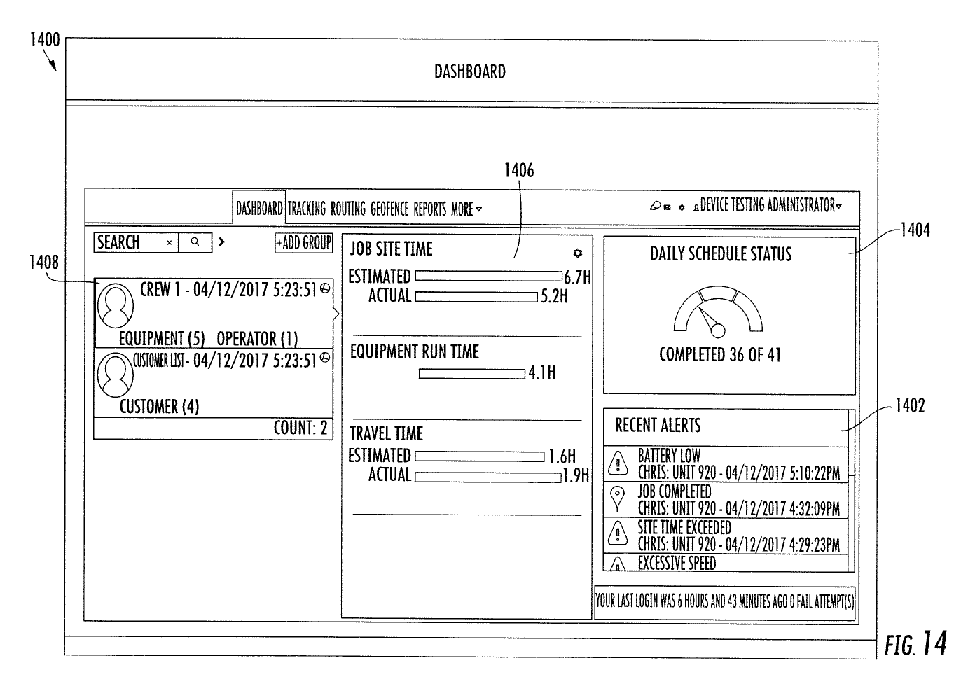

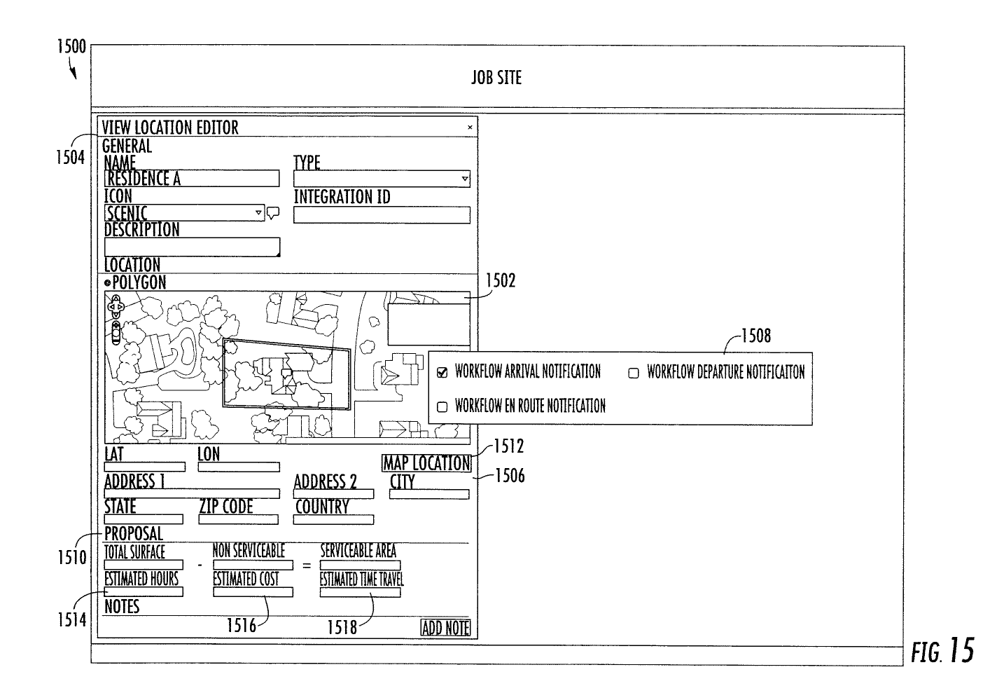

The user interface 1400 shown in FIG. 14 displays an additional or alternative dashboard screen. Among other information, the dashboard screen includes a recent alerts list 1402, a status display 1404, and a customizable productivity list 1406. The recent alerts list 1402 includes information relating to the status of a particular crew and/or unit. As shown, the recent alerts list 1402 displays various statuses, including, “Battery Low,” “Job Completed,” “Site Time Exceeded,” and “Excessive Speed.” The time stamp of the alert statuses indicate when each alert was received by the system 132. The status display 1404 shows the progress of a crew and/or fleet for the daily schedule. For example, as shown, the status display 1404 indicates that 36 out of 41 tasks have been completed for the day.

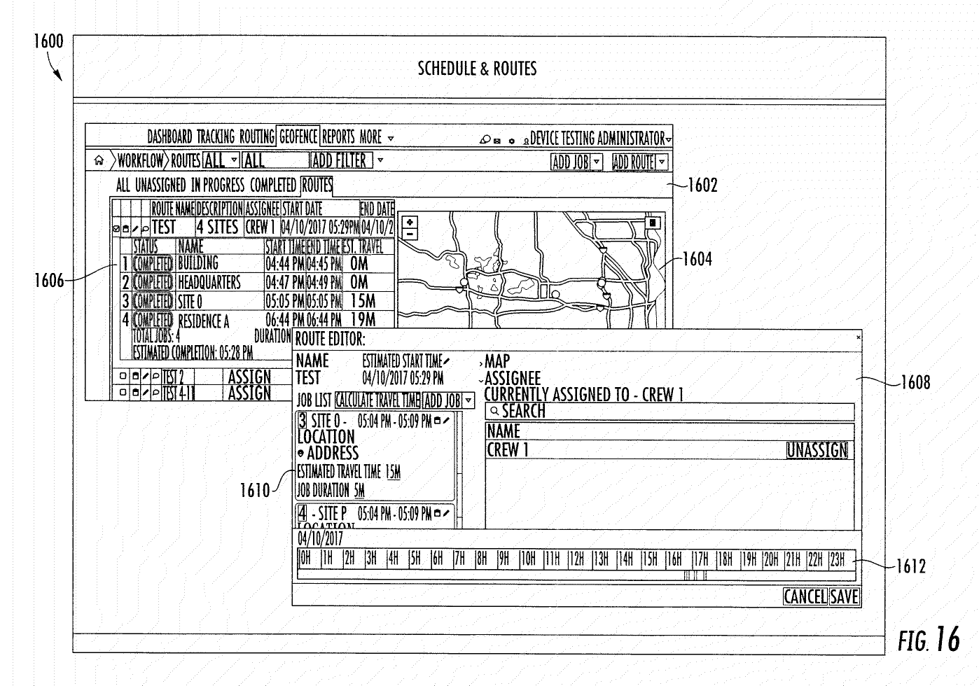

The user interface 1500 shown in FIG. 15 displays a job site screen. The job site screen includes a map 1502, a location editor 1504, a mapping feature 1506, customer notification options 1508, and a proposal estimator 1510. The mapping feature 1506 can be used to locate a specific jobsite location on the map 1502. A user can input the latitude and longitude data or the address and press the “Map Location” selection 1512 to view the jobsite on the map 1502. Additionally, or alternatively, the user can select a location on the map 1502 for the jobsite and the latitude, longitude and address are automatically pulled into the system. The user can also draw or create a geo-zone shown as 1520. The geo-zone area information is pulled into the proposal estimator 1510 described below. The customer notification options 1508 allow a user to customize the notifications that the customer receives during the completion of the job. For example, the user can select from an “Arrival Notification,” which will provide the customer with a notification upon the crew's arrival to the jobsite, a “Departure Notification,” which will provide the customer with a notification upon the crew's departure from the jobsite, and an “En Route Notification,” which will provide the customer with a notification when the crew is on the way to the jobsite. The proposal estimator 1510 includes various inputs (e.g., total surface, area size pulled from geo-zone, non-serviceable area, serviceable area, location) to calculate the estimated hours 1514, estimated cost 1516, and estimated travel time 1518.

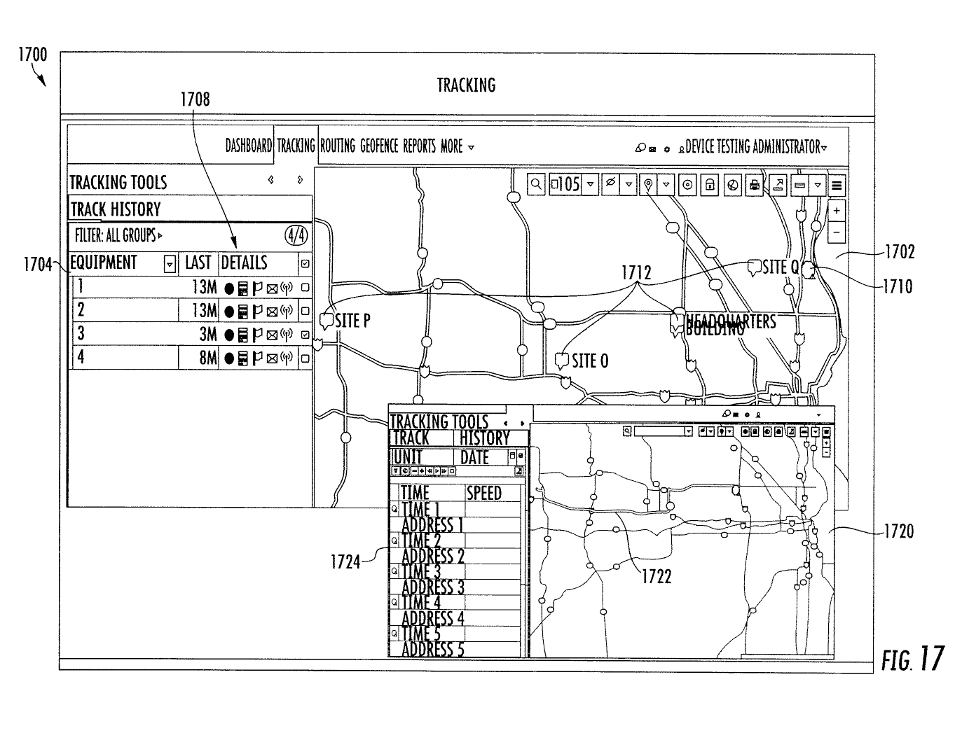

The user interface 1600 shown in FIG. 16 displays a schedule screen 1602 and a routes screen 1608. The schedule screen 1602 includes a map 1604 indicating the positions of scheduled jobs for a particular crew and a job list 1606 showing the names of the jobsites and the estimated travel time and start and end times. The routes screen 1608 shows the job list 1610 for a particular crew. The job list 1610 shows the name, location, estimated travel time, job duration, and so on for each job scheduled for that crew. The ordering of the job list 1610 can be rearranged by a user dragging and dropping the jobs accordingly. A time visual 1612 is also included with the routes screen 1608. The time visual 1612 shows the time periods during which the crew was at a job site.

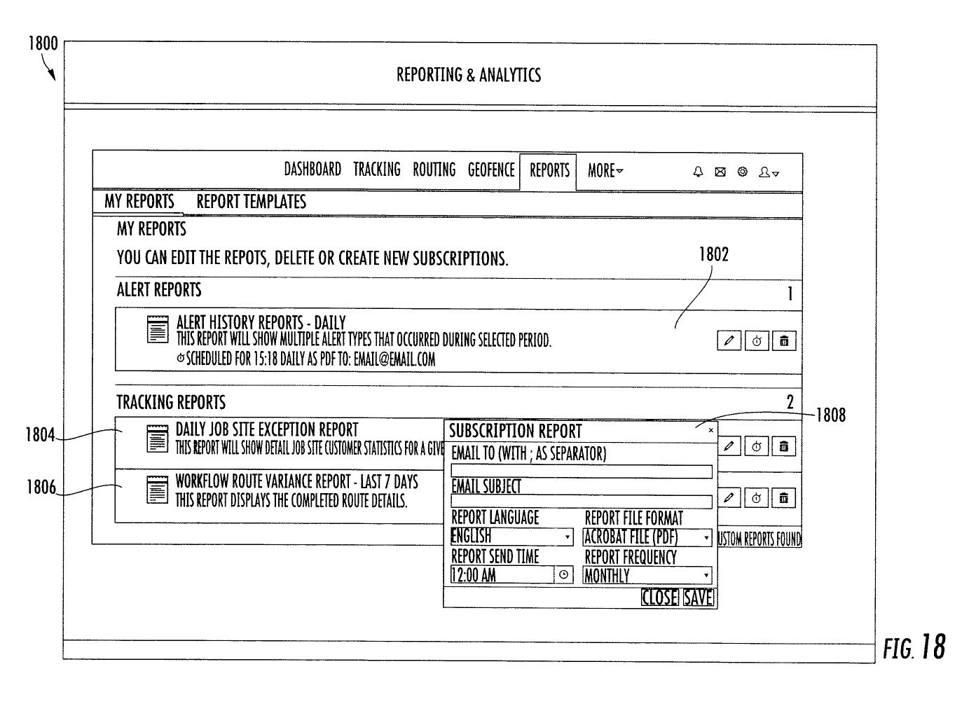

The user interface 1700 shown in FIG. 17 displays a tracking screen including a map 1702 showing the crew location 1710 and the jobsites 1712 scheduled for the crew. The user interface 1700 also includes an equipment list 1704 with details regarding the equipment used by the crew and each equipment's status details 1708. The inset tracking screen 1714 displays a route map 1720 including the crew route history 1722. The crew route history is also included as a crew route list 1724 showing locations of the crew throughout the day, including the time the crew was at that location and the tracked speed of the crew.

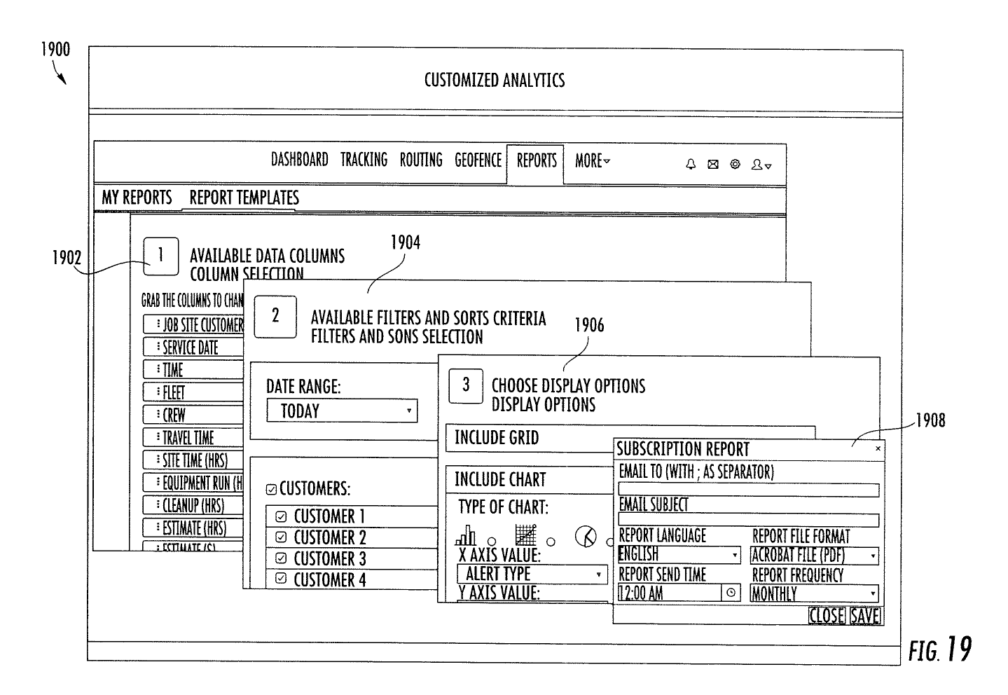

The user interface 1800 shown in FIG. 18 displays a reports screen. The reports screen allows for custom configuration of received reports and alerts. The reports screen includes an alert history reports option 1802, a daily job site exception report 1804, and a workflow route variance report 1806. The reports sent to a user can be on-demand or scheduled to be sent to the user on a regular basis. The alert history reports option 1802 allows a user to preset a time and frequency (e.g., daily) of reports including various alert types. To schedule a subscription to alerts, the user can input subscription preferences into subscription screen 1808. The report alert types can include crew location, crew route, fleet productivity/efficiency, fleet profitability, equipment runtime, other equipment alerts, etc. When selected, the daily job site exception report 1804 displays the detailed job site customer statistics and the workflow route variance report 1806 displays the completed route details for a crew.

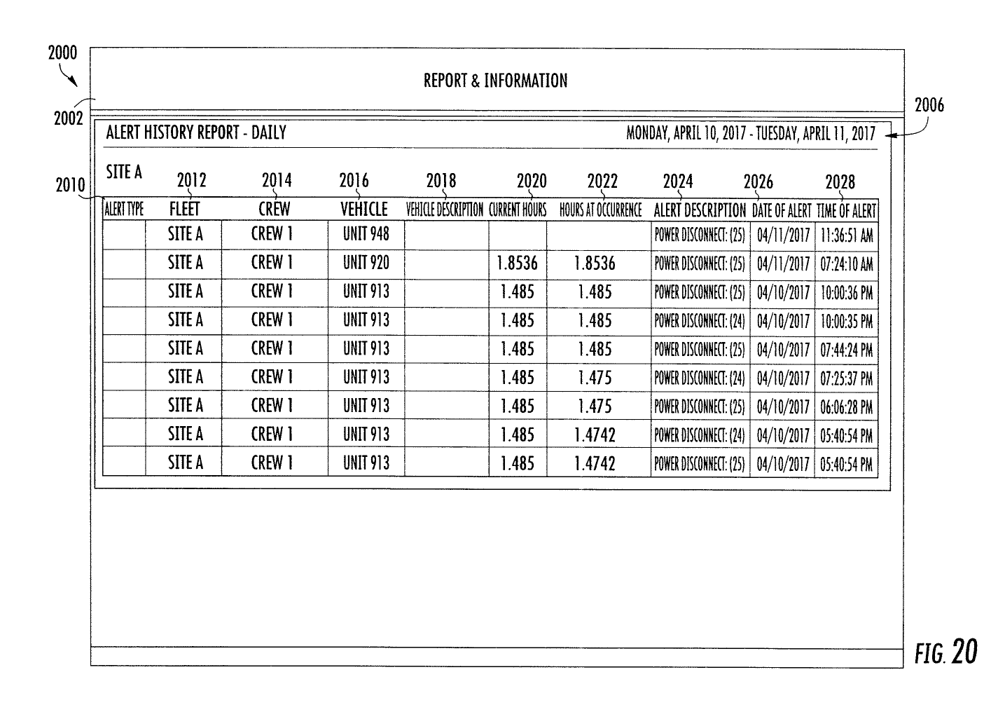

The user interface 1900 shown in FIG. 19 displays customizable analytics such that a user can input preferences regarding which types of reports he/she would like to receive. The customizable analytics include data fields 1902, which can include job site customer name, service date, time, fleet, crew, travel time, site time, equipment run time, cleanup time, job completion estimation time, and so on. The customizable analytics also include filter and sorting options 1904. For example, these options 1904 may include filtering by date range and sorting by customer name. The customizable analytics also include display options 1906, which include, but are not limited to, grids, charts, maps, etc. The customizable analytics further include formatting options 1908 (e.g., subscription options), including the user's preference for time and frequency of reports.

The user interface 2000 shown in FIG. 20 displays a report 2002. The report 2002 may be generated from the above-described subscription or on-demand reporting requests submitted by a user via user interfaces 1800 and 1900 shown in FIGS. 18-19. The report 2002 can display various alert types 2010 over a pre-selected date range 2006. The report 2002 may include, but is not limited to, a fleet name 2012, a crew name 2014, a unit name/number 2016, a unit description 2018, current runtime 2020, time at alert 2022, alert description 2024, date of alert 2026, and time of alert 2028.

The map used as a “geo-zoning” device may additionally be used to determine job scheduling and work crew placement and/or compensation. As an example, team “A” includes three units scheduled to complete ten job sites and team “B” includes two units scheduled to complete eight job sites. Thus, the units may be redistributed based on the amount of work to complete at those job sites or based on information about employee absences or scheduled maintenance of units. As another example, weather reports may be used to avoid inclement weather. As such, the scheduling of one job site may be earlier in the day if inclement weather is forecast to hit that area in the afternoon. As a further example, the map may be used for route optimization such as reducing the amount of drive time between jobs, sales follow-ups when already in a specific area for a scheduled job, picking up additional jobs if ahead of schedule, etc.

In some arrangements, when used as a geo-zoning device, the map feature allows users to enter an address, radius of job zone, and/or draw a route or area of job zone to determine job specifics in that geo-zone including productivity, runtime, number of units, types of units, employees, etc. Furthermore, the geo-zoning device allows a user to designate a geo-zone in which a unit should be positioned during completion of a particular job. The designation of a geo-zone allows tracking of whether units are in or out of the geo-zone during job completion. In turn, this can allow a user to view which operators are out of the geo-zone and how long those operators have been outside of the geo-zone.

The fleet management system 132 may be used in reactive, predictive, and preventative scenarios. First, as an example of a reactive scenario, the fleet management system 132 can be used to determine the a particular unit is overheating and needs immediate service. Thus, assets can then be rebalanced based on what unit may be ahead of schedule at the time that could replace the overheated unit. As another example, a new client calls for an urgent service request and the fleet management system 132 can be used to determine the connected fleet 122 or unit 102 that has bandwidth to take on an extra immediate job. As a further example, if a trailer full of connected units 102 was stolen, a current location of those units can be determined. Furthermore, even if not stolen, a current location of any particular unit 102 can be tracked.

Second, as an example of a predictive scenario, the fleet management system 132 can be used to determine the service status of units 102 and when to optimally schedule downtime of the units 102. As another example, the on-time versus runtime for a specific client may be tracked and as such, a profitability for each client can be measured. As yet another example, fuel cost may be higher than usual in a particular month and the fleet management system 132 may display information regarding the unit 102 that has the highest and/or excessive fuel consumption. As a further example, historical operating statistics sorted by connected fleet 122 and by unit 102 can be shown via the fleet management system 132. This may be used to rebalance fleets or routes to jobs.

Third, as an example of a preventative scenario, the fleet management system 132 can be used to determine that a particular unit 102 will be down for service the next day and a determination whether to redistribute units or reassign employees to other fleets can be made based on this information. As another example, the average effectiveness of a fleet 122 can be determined and this may be used to decide whether to take on more business without adding any resources or whether there are crew performance issues. As a further example, bad weather may be forecasted and how that will impact any scheduled jobs may be determined by the fleet management system 132.

The fleet management system 132 is configured to monitor the units 102 and personnel operating the units 102 to facilitate improvements to the efficiency and cost-effectiveness of the connected fleets 122. The system 132 can efficiently schedule jobs, evaluate personnel performance, provide feedback to personnel, recommend bid values on potential jobsites, calculate total cost of ownership of a unit, and provide recommendations regarding each unit (e.g., retire unit, take unit in for repairs, keep unit for two more years, etc.).

When referred to herein, “operational parameters” include, but are not limited to, engine on/off status, power takeoff switch status, engine controller data, fuel usage, belt sensor data, air and oil filter switch status, angle of operation, acceleration, air/fuel mixing device data (e.g., electronic fuel injection (EFI) data, carburetor sensor data), one or more indicator lights, air cleaner pressure, low oil pressure, tire pressure, air temperature, oil temperature, auxiliary temperature, and so on.

When referred to herein, “operator input” includes, but is not limited to, operator schedules, operator routes, operator location, fuel costs, repair and maintenance needs, and so on.

When referred to herein, “maintenance personnel” includes, but is not limited to, in-house maintenance personnel of the fleet operator, third party dealers, third party repair shops, the operator, and so on.

When referred to herein, “external factors” include, but are not limited to, weather reports, traffic reports, and scheduling issues.

The system 132 is configured to monitor the operational parameters, costs of ownership, maintenance needs, and the location and movement of each unit 102. Operational parameters of each unit 102 can be determined from inputs from the engine. For example, the runtime of the engine 202 and the power takeoff 204 can be used to determine when the unit 102 is on and when the unit 102 is in use. The usage time is tied to power takeoff activation. The power takeoff drives an implement (e.g., mower blade) that is monitored by a power takeoff switch or sensor that is activated when the power takeoff is engaged. When the power takeoff is engaged or activated, the system 132 can presume that the unit 102 is in use (e.g., is being used to mow grass). In other embodiments, the location of the unit 102 is monitored. For example, if the unit 102 is moving at a certain speed, it can be determined that the unit 102 is in use (e.g., mowing, etc.) and if the unit 102 is stationary, it can be determined that the unit is not in use. The engine 202 runtime can be used to determine how long the unit 102 is on compared to how long the unit 102 is in use. A productivity value can be determined by dividing usage time by engine run time. For example, if the usage time is seven minutes and the engine run time is ten minutes, the productivity value is determined to be 70 percent.

Fuel usage of the unit 102 can be determined by monitoring the fuel gauge of the unit 102. The number of times an operator fills the unit over time versus the engine and operating runtime can determine the fuel usage. Average fuel costs can be determined using operator input (e.g., inputting how much the operator paid for fuel) or basing the fuel cost on a market average (e.g., in a particular city, the fuel cost is $2.50/gallon, etc.).

The system 132 is further configured to monitor the health of each connected unit 102. To monitor some systems of each unit 102, the engine controller is configured to generate and transmit fault codes regarding fault conditions that may indicate needed maintenance, failure modes, warnings, etc. The system 132 receives the fault codes and determines what maintenance or repairs are needed for each unit 102 and schedules time for maintenance and repairs. Some repairs may be urgent and need to be completed as soon as possible. In this case, the repairs may be immediately scheduled based on availability. Maintenance can be scheduled on a routine basis (e.g., recurring every other week, every 400 hours, etc.). Maintenance can also be determined by monitoring operational time of the unit 102, including engine run time and/or usage time (e.g., mow time or time power take off is engaged). In some arrangements, the engine run time may be used as an indicator for routine maintenance (e.g., oil change, best adjustment or repair, etc.) and maintenance can be scheduled based on a run time threshold. In some arrangements, the usage time may be used as an indicator for routine maintenance (e.g., oil change, best adjustment or repair, etc.) and maintenance can be scheduled based on a usage time threshold. Alternatively, usage time and run time can both be used to set a maintenance schedule. For example, an oil change is scheduled when either a predetermined number of use hours is exceeded or a predetermined number of run time hours is exceeded, whichever occurs first. In some embodiments, the system 132 can be communicably coupled to a third party, such as a dealer or repair shop to directly transmit the fault codes or other notifications to the third party for maintenance and repair determinations, as described further herein.

The system 132 is configured to monitor the belts (e.g., drive belt, PTO belt, etc.) of the units 102. The belt may be a smart belt configured to determine belt wear and stretch over time. As such, the force on the pulley that carries the belt may be monitored such that reduced force indicates stretch or wear of the belt. Alternatively, the belt can be monitored using depth sensors on the belt to measure wear. Accordingly, the belt would include a sensor that communicates wear and/or stretch to a receiving unit. The system 132 can receive notifications from a unit 102 when the belt has worn a predetermined amount or will soon be worn a predetermined amount so that repairs can be scheduled. The system is further configured to monitor air filters and oil filters using smart filters to notify the system when the filters require changing.

Maintenance and repairs on each unit 102 can be scheduled using a variety of methods. Maintenance and repairs can be directly scheduled with maintenance personnel. The maintenance personnel can receive notifications regarding fault codes, as described above, and can receive notifications regarding other components of the unit 102 (e.g., belt) to automatically schedule the repairs. The maintenance personnel can also receive unit runtime information, described further herein, to automatically recommend maintenance intervals and scheduling for each unit 102. For example, the system 132 can determine that a unit 102 needs maintenance every other week and can send that information to a dealer for scheduling. Maintenance personnel can also remotely determine that a particular unit 102 needs repairs and can schedule those repairs at an optimal time for the maintenance personnel and the operator.

The system 132 can also facilitate real-time ordering and delivery of parts from maintenance personnel. By allowing dealers to directly view notifications regarding maintenance and repair requirements (e.g., fault codes), maintenance personnel can be authorized to automatically send repair parts to a local repair shop or in-house shop for the operator to complete the repair. By notifying maintenance personnel immediately, the repair parts can be sent immediately and the unit can be up and running as soon as possible.

Various inputs and factors may determine maintenance scheduling. As one example, preset operator preferences can be used to determine maintenance scheduling. The operator may preset preferences using the connected unit 102 or a mobile device 113. The operator may maintain a schedule using the mobile device 113 that shows day-to-day plans for operation and downtime. Each operator may preset days of the week or times of the day that the operator would like to use as downtime for maintenance and repairs. For example, an operator may present that he or she always wants to do maintenance on Friday afternoons and that he or she always prefers afternoons to mornings for any necessary repairs. Any maintenance needed on a unit the operator operates can be scheduled on Friday afternoons. Additionally, when repairs are needed on that unit, the maintenance personnel may automatically schedule repairs for the next available afternoon time slot.

As another example, external factors may also be used to automatically determine maintenance scheduling. For example, weather reports may be used to determine that maintenance should be done on a particular day when it may be raining or inclement weather is predicted. The system 132 may automatically schedule maintenance during times of inclement weather to make efficient use of down time of the unit 102, such that potential operational time is not wasted. Furthermore, if the unit 102 requires urgent repairs (e.g., cannot operate without being repaired, etc.), the unit 102 may be prioritized in front of other units that have less urgent repair or maintenance needs.

As another example of scheduling factors, maintenance personnel availability may also be used in determining scheduling such that the system 132 automatically does not schedule maintenance and repair for units 102 during a time when repairs are already scheduled or during a time when the dealer is closed. As such, maintenance personnel can maintain a schedule indicating available time slots for maintenance.

As yet another example, external factors, operator preferences, and maintenance personnel schedules can all be used to determine optimal maintenance and repair scheduling. The system 132 can sync the dealer schedule, the operator schedule, and take into consideration outside factors, such as weather, to determine appropriate times for maintenance and repairs. An operator may set a window or range of time (e.g., three days) that the operator is planning to use as downtime for the units 102, rain may be forecast for one of the days during that range, and the dealer may be closed for one of the days such that only one available day during the operator's downtime schedule is available for repairs. The system 132 may automatically suggest scheduling maintenance and repairs on the day the dealer is open and no rain is forecast during the window of time most convenient for the operator.

The system 132 is configured to determine a total cost of ownership of each unit 102. The cost of repair parts, maintenance, fuel, downtime of the equipment, overall health of the equipment, including age, how often repairs and maintenance are required, and so on, are used to determine the total cost of ownership. Using past data about the unit, the system 132 can predict when the equipment costs more money to maintain and repair than the revenue the equipment is generating. The system 132 can also receive input from the operator and other personnel regarding fuel usage costs, unit performance, etc. Thus, the system 132 can predict when the equipment needs to be replaced. The system 132 can further compare the total cost of ownership of an existing unit to the expected cost of ownership of a new unit to make purchase recommendations. Furthermore, the system 132 is additionally configured to determine if the recommended new unit should be a one-for-one replacement or if the new unit should be of a different type (e.g., different deck size, standing, riding, etc.) to improve overall efficiency of the fleets 122.

The system 132 is additionally configured to monitor operators of the units 102. The system 132 can monitor the operators both on the job and between jobs. To monitor the operators on the job, the system 132 may monitor a mobile device 113 of the operator and/or a connected unit 102. Each operator may have a connected mobile device 113 to interact with the system 132. The mobile device 113 communicates the location of the operators to the system 132 such that the location of the operators can be tracked. Thus, it can be determined when and for how long an operator is within or outside a job-site boundary. In another embodiment, each unit 102 is connected directly to the system (e.g., via WiFi, network, cellular tower, etc.) such that the location of each unit 102 can be determined. In some embodiments, both the location of a mobile device 113 and the location of the unit 102 is tracked such that the location of the operator relative to the unit 102 can be determined and the amount of time an operator spends on or near a unit 102 is discernable. The amount of time an operator is near or on a unit compared to the amount of time an operator is away from unit may be used to determine potential areas of improvement for the operator. The comparison may reveal that an operator is spending too much time on break or is inefficient at a particular job site. Additionally, if an operator is taking too much time to complete a job, the system 132 may transmit a notification to the operator (via mobile device 113 or unit 102) indicating the time an operator has to finish the site. As an example, the system 132 may display a countdown timer on the mobile device 113 or the unit 102 indicating the amount of time for the operator to finish the job to be on pace with other operators. As another example, the system 132 may display a colored light (e.g., green, yellow, red) instead of, or in addition to a countdown timer. Furthermore, prior to the operator starting work on the site, the system 132 may display current average job site completion times or expected completion times to the operator.

The system 132 is additionally configured to monitor the route that each operator takes for a specific jobsite. The route can be determined using the location signal from the operator mobile device 113 and/or the connected unit 102. By determining the route for a specific jobsite, the system 132 can determine if the operator is efficiently completing the job (e.g., taking the most efficient route, stopping many times, etc.). Over time, the system 132 can aggregately determine the most efficient route for a particular jobsite and can display specific instructions for an operator prior to the operator starting that jobsite. The system 132 can also determine that a particular operator completes the jobsite in the most efficient manner and suggests the route of that operator to other operators. For example, the system 132 can determine that a particular operator most efficiently mows a jobsite and using the operator route and equipment information, the system 132 can instruct other operators to complete the job in the same manner. The system 132 can display route and jobsite boundary information either directly on the unit 102 or on an operator mobile device 113. Furthermore, the system 132 can display route information for training purposes. An operator can be trained how to mow a particular lot based on the graphic displayed. Additionally or alternatively, the information determined by the system 132 can be sent to a management computing system for display to be reviewed by fleet management personnel.

Using monitored operator time and route information, the system 132 can determine how operators compare to each other with regard to efficiency. Additionally, the system 132 can determine how efficient a particular operator is with regard to a particular jobsite. For example, one operator may be very efficient at jobsite A and very inefficient at jobsite B and a second operator may be very efficient at jobsite B. The system 132 is configured to recommend which personnel to place at which jobsites based partly on the efficiency of each operator with respect to each jobsite. Based on each operator's efficiency information, the system 132 can determine the efficiency of each crew (e.g., set of operators on a particular jobsite). Based on this information, efficiency problems related to a particular crew may be pinpointed by the system 132. Additionally, crews that perform particularly well at certain jobsites can be scheduled at those jobsites instead of at those where the crew may be less efficient.

The system 132 can also determine the preferred size and type of equipment to use (e.g., 42-inch deck mower versus 50-inch deck mower, standing versus riding, etc.) at particular job sites by comparing the operational data from the units 102 to the terrain and size of the jobsite. For example, the system 132 can automatically determine the type and quantity of equipment used at a jobsite using jobsite data. The system 132 can receive details regarding the jobsite size, number of water features, trees, landscaping, and other obstacles, and quantity and grade of sloped terrain and use that information to determine types and quantity of equipment recommended for a particular jobsite. For example, if a particular jobsite has many obstacles including trees, bushes, and ponds and is relatively small in size, the system 132 may recommend that the operator use a small mower to complete the job. The system 132 can also receive input from operators who have completed the job previously regarding which type of equipment was used, determine the efficiency of that operator on the job and recommend the equipment to other operators completing the job. Additionally, the system 132 may rate particular sites based on complexity and suggest different equipment types for the less complex sites than for more complex sites. The system 132 improves the efficiency at existing sites and can recommend equipment for potential new sites based on store historical performance information.

The system 132 may also use site complexity ratings for bidding on sites. The system 132 may compare existing customer's sites, the complexity of the sites, and the operating costs (e.g., how many personnel, types of equipment, how long to complete the site, mowing patterns, etc.) to complete the sites to sites that are bidding opportunities to determine appropriate bidding values. Furthermore, the system 132 may be configured to compare potential new sites to existing sites to determine how the new site may fit in with routes for the existing sites. For example, a potential jobsite located far away from existing jobsites should be bid at a higher price (due to additional travel time) than a similar potential new jobsite located near existing sites (where travel time between jobsites is reduced).

Further, the system is configured to monitor personnel between jobs. The system 132 can use the mobile device 113 location or the connected unit 102 location to determine operator actions between jobs. For example, the system 132 can determine how many stops an operator makes between jobs and if the operator takes a detour from the normal path of travel between the jobs using GPS from the mobile device 113 or connected unit 102. The connected unit 102 can transmit GPS signals routinely to the system 132 to show location status. The system 132 can determine if the connected unit is being transported or if the unit 102 is in use based on the distance covered in a set amount of time (e.g., if the unit 102 transmits that it is covering further distances over shorter periods of time, it is likely the unit 102 is being transported to another job site). Furthermore, the system 132 can determine if the connected unit 102 is being transported or is in use based on engine on/off status. For example, if the engine 202 is off and the unit 102 is moving, then the unit 102 is being transported between jobsites. In some embodiments, the system 132 can alert the operator (e.g., via operator mobile device 113, operator vehicle display, etc.) that he has traveled in a wrong direction or is taking an inordinate amount of time to travel between the scheduled jobs. For example, the system 132 may send an alert to the operator's mobile device with a notification stating, “operator needs to arrive at next scheduled job site in five minutes,” or “operator is shown to be ten minutes behind schedule,” and so on.

The system 132 is also configured to monitor the route each operator takes between jobsites. A designated route can be preset, which the operator may be instructed to follow (within reasonable deviation) between jobs. As with route monitoring at a jobsite, the route can be determined using the location signal from the operator mobile device 113 and/or the connected unit 102. Furthermore, the location signal from a vehicle 107 associated with the connected unit 102 and/or the operator can be used to track the operator route. In this arrangement, the vehicle 107 is used to transport one or more connected units 102 to, from, and between jobsites. The vehicle 107 may be equipped with a location positioning sensor (e.g., location positioning sensor 210 described in FIG. 2). The location positioning sensor is structured to receive location data and determine a location or receive information indicative of a location of the vehicle 107. In one embodiment, the location positioning sensor includes a GPS or any other type of location positioning system. As such, the location positioning sensor receives latitude data, longitude data, and any other type of location or position data to determine the location of the vehicle 107. In other embodiments, the location positioning sensor receives location data from the enterprise computing system 108 that indicates the location of the vehicle 107. In still other embodiments, the location positioning sensor receives an explicit location identification from a user of the vehicle 107. In further embodiments, the location positioning sensor communicates information about a vehicle 107 outside of a predetermined route. For example, the location positioning sensor may be used to determine that a vehicle 107 has left a designated route between jobsites for longer than a predetermined period of time and/or at a distance greater than a predetermined threshold distance. In some embodiments, the location data can include historical location data tracking the movement of the vehicle 107 that can be viewed by a user at a later time or date.

In some embodiments, the system 132 can send a notification to the customer when the operator is about to or has arrived at the customer's job site. In some arrangements, the system 132 can send a notification including an anticipated time of arrival. The system 132 can contact the customer directly via messaging (e.g., text message, e-mail, push notification, etc.). The system 132 can further provide a notification to the customer when a job is complete. In some arrangements, this notification can include a picture of the completed job. In some arrangements, after transmission of the completion notification, the system 132 generates and transmits a customer feedback request to the customer. In these arrangements, the system 132 may immediately send the customer feedback request or may send the feedback request at a later date.

The fleet management system 132 is configured to determine the optimal schedule and placement of units 102 and/or fleets 122 on a day-to-day basis. The system 132 is configured to pull in third party data, such as weather forecasts and traffic conditions, to determine optimal scheduling. For example, the system 132 can determine that there is an 80 percent chance of rain in a specific location at a specific time and reroute the fleets 122 to complete jobs in other locations during that time and reschedule the fleets 122 to complete jobs in that location during a time when rain is not forecast. As a further example, the system 132 can determine that a traffic accident has occurred on the route typically taken from one jobsite to the next and send notifications to personnel and suggest an alternative route to get to the next jobsite. The system 132 can additionally reconfigured routes and fleets 122 in response to a notification that a unit 102 is out of order.

Further, some sites may have certain scheduling limitations. Thus, the system 132 may receive preset preferences from the customer regarding these limitations or may automatically determine the scheduling limitations based on the profile of the customer. For example, a church lot may require that the lawn be mowed on a day other than Sunday. As another example, it may be undesirable to mow the lawn of a school in the afternoon when children are leaving and activity around the school is at its highest during the day.

Additionally, customers may require last-minute job completions during the day. To schedule these types of jobs into the schedule, the system 132 may use empty windows of time during the day to fit jobs in between existing pre-scheduled jobs. The nearest available fleet 122 and personnel may be rerouted to the “on-demand” job in between two existing scheduled jobs. The system 132 may also back-fill jobs to be completed with a fleet 122 that is ahead of schedule into the empty windows of available time. The system 132 is also configured to automatically reschedule jobs when one work crew runs into unexpected delays (e.g., unit downtime, etc.).

In some arrangements, the fleet management system 132 is used to manage a fleet of outdoor power equipment in a salt/snow application. For example, the system 132 can be used to manage salt spreaders, plows, snow throwers, etc. as the connected units 102. In salt/snow applications, the system 132 can be used to schedule salting and/or plowing operations, routing of connected units, arrival and departure times of the units, and alerts of operation and/or location of the units. The system 132 can further monitor the weight of salt in the connected units prior to and during completion of a job for billing purposes (e.g., the salt start weight subtracted by the end weight is used to determine amount of salt used). In addition, the system 132 can track the route of salting/plowing operations and the width of affected area during salting and plowing. The tracked route and width of application can then be provided in the form of a map to the customer. In salting applications, the system 132 monitors the rate at which salt is applied and compares the rate of application to the speed of travel of the unit 102. This comparison can be used to control the application rate of salt to provide consistent and accurate coverage of salt. The sensors that may be included with units completing a salt/snow application can include, but are not limited to, a speed sensor, location positioning sensor, accelerometer, hopper scales, spreader on/off sensor, and revolutions per minute sensor on spinners. The system 132 can further provide guidance to an operator within the cab of a connected unit 102 such that any overlap of coverage may be prevented or managed.

In some arrangements, the fleet management system 132 is used to manage a fleet of outdoor power equipment in a fertilizer/chemical application. For example, the system 132 can be used to manage fertilizer spreaders, etc. as the connected units 102. In fertilizer/chemical applications, the system 132 can be used to schedule fertilizer and/or chemical spreading operations, routing of connected units, arrival and departure times of the units, and alerts of operation and/or location of the units. The system 132 can further monitor the weight of fertilizer or chemical in the connected units 102 prior to and during completion of a job for billing purposes (e.g., the fertilizer start weight subtracted by the end weight is used to determine amount of fertilizer used). In addition, the system 132 can track the route of fertilizer/chemical spreading operations and the width of affected area during spreading. The tracked route and width of application can then be provided in the form of a map to the customer. In spreading applications, the system 132 monitors the rate at which fertilizer is applied and compares the rate of application to the speed of travel of the unit 102. This comparison can be used to control the application rate of fertilizer to provide consistent and accurate coverage of fertilizer. The sensors that may be included with units completing a fertilizer/chemical spreading application can include, but are not limited to, a speed sensor, location positioning sensor, accelerometer, hopper and/or tank scales, spreader on/off sensor, and revolutions per minute sensor on spinners. The system 132 can further provide guidance to an operator within the cab of a connected unit 102 such that any overlap of coverage may be prevented or managed.

In some arrangements, the fleet management system 132 is used in an asset management application. For example, the fleet management system 132 is used to schedule jobs, track which operators are using the units 102, monitor the operation and location of other tools at the job site (e.g., trimmers, blowers, chain saws, etc.), and identify the last known location of those tools. To monitor operators, the system 132 may include wearable sensors that can track the position of the individual operator. To monitor proximity of units, the system 132 may include proximity or reed sensors. To monitor operational aspects of the units, the system 132 may include ignition sensors, accelerometers, speed sensors, location positioning sensors, etc.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. §112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

What is claimed is:

1. A fleet management system for use with a lawn mower, the system comprising:
a connected lawn mower comprising a prime mover and at least one mower blade; and
a processing circuit communicably coupled to the connected lawn mower, the processing circuit comprising a processor and memory, the memory structured to store instructions that are executable by the processor and cause the processing circuit to:
receive a cost input indicating an amount of money to complete one or more jobs;
receive an on-site time for the one or more jobs;
calculate a profitability value for the one or more jobs based on at least the cost input and the on-site time;
generate a profitability report for the one or more jobs based on the calculated profitability value;
receive operational data from the connected lawn mower, wherein the operational data comprises a prime mover runtime;
calculate an efficiency value for the connected lawn mower based on at least the prime mover runtime and the on-site time;
generate an efficiency report for the connected unit based on the calculated efficiency value; and
transmit the efficiency report and the profitability report to a computing system.

2. The fleet management system of claim 1, wherein the processing circuit is further caused to receive location data from the connected lawn mower, wherein the location data comprises a connected lawn mower location and a predetermined area of operation;
wherein the predetermined area of operation includes a jobsite area with a jobsite perimeter;
wherein the on-site time includes an amount of time the connected lawn mower location is within the predetermined area of operation.

3. The system of claim 1, wherein the efficiency value comprises a ratio of the prime mover runtime of the connected lawn mower over the on-site time.

4. The system of claim 1, wherein an expected efficiency value is received by the processor;
wherein if the calculated efficiency value is less than the expected efficiency value, the processing circuit is caused to transmit an efficiency alert to the computing system.

5. The system of claim 1, wherein the memory is structured to receive an expected margin of profitability;
wherein if the calculated profitability value is less than the expected margin of profitability, the processing circuit is caused to transmit a profitability alert to the computing system.

6. The system of claim 1, further comprising:
a location position sensor attached to the connected lawn mower;
wherein the processing circuit is further caused to:
receive position data from the location position sensor, wherein the position data is comprised of one or more position data points gathered at preset intervals;
determine a route for the connected lawn mower based on the position data;
determine time data for each position data point;
receive expected time data including a time tolerance for one or more position data points;
wherein the processing circuit transmits an alert to the computing system if the time data is not within the time tolerance of the expected time data.

7. The system of claim 6, wherein the processing circuit is further caused to:
receive a preset route and a route tolerance based on a known route between jobsites, wherein the route tolerance is a preset distance from the preset route;
determine that the connected lawn mower is outside of the route tolerance from the preset route based on the position data;
transmit an off-route indication to the computing system.

8. The system of claim 1, wherein the processing circuit is further caused to:
receive scheduling input from an operator, wherein the scheduling input includes an operator schedule;
determine a maintenance schedule based on the operational data;
determine a scheduled maintenance time based on the maintenance schedule and the operator schedule;
transmit the scheduled maintenance time to the computing system.

9. The system of claim 8, wherein the processing circuit is further caused to:
receive external factor data;
receive a maintenance personnel schedule from maintenance personnel;
determine the scheduled maintenance time based on the maintenance schedule, the operator schedule, the maintenance personnel schedule, and the external factor data;
transmit the scheduled maintenance time to the computing system;
determine repair data from the connected lawn mower, wherein the repair data comprises a component of the connected lawn mower that requires repairs; and
transmit the repair data to the computing system.

10. The system of claim 1, wherein the processing circuit is further caused to:
receive location data from the connected lawn mower, wherein the location data comprises a connected lawn mower location and a predetermined area of operation;
receive a predetermined time threshold;
receive an operator location from a mobile device of the operator;
receive an indication that the operator location is outside the predetermined area of operation for longer than the predetermined time threshold; and
transmit an alert to the mobile device of the operator to return to the predetermined area of operation.

11. The system of claim 1, wherein the processing circuit is further caused to:
receive location data from the connected lawn mower, wherein the location data comprises a connected lawn mower location and a predetermined area of operation;
determine an operation time for the connected lawn mower based on the operational data;
compare the operation time for the connected lawn mower to an average operation time for the predetermined area of operation;
determine the operation time is over the average operation time; and
transmit an alert to the connected lawn mower that the operation time is over the average operation time for the predetermined area of operation.

12. The system of claim 10, wherein the processing circuit is further caused to:
determine a preferred route for the predetermined area of operation by compiling historical route data from past jobs at the predetermined area of operation; and
transmit the preferred route to the connected lawn mower.

13. The system of claim 12, wherein the processing circuit is further caused to:
determine preferred equipment for the predetermined area of operation by compiling historical equipment data from past jobs at the predetermined area of operation; and
transmit the preferred equipment to the computing system.

14. A connected unit comprising:
a prime mover; and
communication circuitry communicably coupled to a fleet management system, wherein the fleet management system is configured to:
receive a cost input indicating the amount of money to complete one or more jobs;
receive an on-site time for the one or more jobs;
receive operational data from the connected lawn mower, wherein the operational data comprises a prime mover runtime;
calculate an efficiency value for the connected lawn mower based on at least the prime mover runtime and the on-site time;
calculate a profitability value for the one or more jobs based on at least the cost input and the on-site time;
generate an efficiency report for the connected unit based on the calculated efficiency value;
generate a profitability report for the one or more jobs based on the calculated profitability value; and
transmit the efficiency report and the profitability report to a computing system.

15. The connected unit of claim 14, wherein the processing circuit is further caused to receive location data from the connected lawn mower, wherein the location data comprises a connected lawn mower location and a predetermined area of operation;
wherein the predetermined area of operation includes a jobsite area with a jobsite perimeter;
wherein the on-site time includes an amount of time the connected lawn mower location is within the predetermined area of operation.

16. The connected unit of claim 14, wherein the efficiency value comprises a ratio of the prime mover runtime of the connected unit over the on-site time.

17. The connected unit of claim 14, wherein an expected efficiency value is received by the fleet management system;
wherein if the calculated efficiency value is less than the expected efficiency value, the processor is configured to transmit an efficiency alert to the computing system.

18. The connected unit of claim 14, further comprising:
a location position sensor attached to the connected unit;
wherein the fleet management system is further configured to:
receive position data from the location position sensor, wherein the position data is comprised of one or more position data points gathered at preset intervals;
determine a route for the connected unit based on the position data;
determine time data for each position data point;
receive expected time data including a time tolerance for one or more position data points;
wherein if the time data is not within the time tolerance of the expected time data, an alert is transmitted to the computing system.

19. The connected unit of claim 18, wherein the fleet management system is further configured to:
receive a preset route and a route tolerance based on a known route between jobsites, wherein the route tolerance is a preset distance from the preset route;
determine that the connected unit is outside of the route tolerance from the preset route based on the position data;
transmit an off-route indication to the computing system.

20. The connected unit of claim 14, wherein the fleet management system is further configured to:
receive scheduling input from an operator, wherein the scheduling input includes an operator schedule;
determine a maintenance schedule based on the operational data;
determine a scheduled maintenance time based on the maintenance schedule and the operator schedule;
transmit the scheduled maintenance time to the computing system.
